(19) United States
(12) Patent Application Publication
(10) Pub. No.: US 2014/0278786 A1
(43) Pub. Date: Sep. 18, 2014

(54) SYSTEM AND METHOD TO SURVEY AND EVALUATE ITEMS ACCORDING TO PEOPLE'S PERCEPTIONS AND TO GENERATE RECOMMENDATIONS BASED ON PEOPLE'S PERCEPTIONS

(71) Applicant: Twain Liu-Qiu-Yan, New York, NY (US)

(72) Inventor: Twain Liu-Qiu-Yan, New York, NY (US)

(21) Appl. No.: 14/205,221

(22) Filed: Mar. 11, 2014

Related U.S. Application Data
(60) Provisional application No. 61/786,247, filed on Mar. 14, 2013.

(51) Int. Cl. G06Q 30/02

(52) U.S. Cl. CPC G06Q 30/0201; G06Q 30/0251
USPC 705/7.32

(57) ABSTRACT

A perceptual evaluation system and method are disclosed that collects, categorizes, evaluates, connects and manages the primary market research of items and combines it with secondary market research to create perception profiles of people and their consumption behaviors, and generates recommendations based on people's perceptions. The system and method enable the perception evaluation of items by users via (click or touch) drag-and-drop mechanisms in a survey processes and applies a novel perception rating scale to categorize, evaluate and cohere the items. The items may include word text, audiovisuals and maps, and the system is deployable on Web and mobile browsers, Web and mobile devices and smart TV devices. The system's output includes recommendations presented as perception maps and other data visualizations.

### PRIORITY CLAIMS/RELATED APPLICATIONS

This application claims the benefit of and priority to under 35 USC 119(e) and 120 U.S. Provisional Application No. 61/786,247 entitled “System and method to survey and evaluate items according to people's perceptions and to generate recommendations based on people's perceptions” filed Mar. 14, 2013, the entire contents of which are incorporated herein by reference.

### FIELD

This system relates to the fields of commerce (herein this term encompasses mobile, retail and Web-based commerce), market research, personality and psychometric tests, data analytics (including probabilistic, semantic and sentiment), Web-mobile-smart TV surveys, ratings, reviews and recommendation systems, Artificial Intelligence and human-machine intelligence.

### BACKGROUND

The comprehensive detail provided herein is intended to provide context on how this system and method overcomes the limitations of prior art approaches to data collection in commerce, market research, personality and psychometric tests, data analytics (including probabilistic, semantic and sentiment), Web-mobile-smart TV surveys, and ratings, reviews and recommendation systems, Artificial Intelligence and human-machine intelligence. It implements much more granular specifications for data collection in commerce (including at Point of Purchase rather than only post-purchase feedback as currently happens), survey format structures, input quality, rating scales, user interactions, data analytics (probabilistic, semantic, sentiment and human-machine intelligence), and the generation of recommendations to make them more accurate, calibrated, relevant, efficient and effective.

This system and method has been created to improve the commerce experience, market research, the insights extractable from commercial activity and the recommendations provided by it. Companies need market research on people and their consumption behaviors to enable them to produce, recommend and sell products, brands, content, relationships, services and experiences to satisfy the needs and wants of consumers. The market research collected also enables companies to create targeted personalized advertising, build prediction models of potential future consumption and adjust resource allocations to deliver goods, services and experiences, and to improve upon these for consumers.

However, prior art systems and methods of market research for commerce have been skewed towards the collection and analysis of quantitative data (e.g., $ price of product, quantities of the product available, weight of the product, length×height×width measurements of the product, $ volume of product sold, longitude-latitude of where the product is available, number of people who previously bought the item, delivery times), socio-demographic data of the consumer (e.g., name, date of birth, gender, marital status, occupation, address, education level, size of family, household income levels, publications read, household goods bought, household expenditure levels, how many of their friends like or recommend the product across social media), behavior data (e.g., where they click on a web page or in a mobile application, length of time they stay on a web page or interact with each component of a mobile application, frequency of times they log-in, how long their comments are, $ amount of applications they download, how many devices they buy, geo-location of where they are when they activate or interact on their mobile device, number of social connections they make, where and how many times they check-in, length of time they watch a video, how many adverts they skip) and the probabilistic correlation of that quantitative data. Moreover, the format of the market surveys with their “tick the box”, “click the button”, “select the dropdown option”, “fill in the text space” and “cookies in the browser” has limited the types of data that is collectible and the interactivity of the user with the market surveys.

Market research was first developed in the late 1920s by Daniel Starch as a business system, in line with the emergence of the advertising industry in the US at that time. Starch's method involved market researchers with pen and paper stopping people in the streets, showing them a hardcopy of a magazine and interviewing them about whether or not they read the publication and recognized any of the adverts contained within the publication. The interviews comprised binary two-option “Yes/No” type questions and basic socio-demographic information about the magazine reader such as name, address, age and gender.

Another origination of market research was in government census methods from the nineteenth century onwards. The census survey is a procedure of systematically acquiring and recording socio-demographic information about members of a population, and applying probabilistic and statistical methods to correlate the relationships between different sets of that information to gain some insights. Typically, government census in the US happens every ten years.

The earliest forms of market research, though, were established in the political and democratic processes of Plato's Republic around 380 BC and in the Roman forums with people voting with their thumbs-up (positive), thumbs-down (negative) and thumbs sideways (neutral). This was a system for collecting and counting what the sample population thought about an item, e.g., whether or not a gladiator should be allowed to live or be killed, and how many senators in the Senate agreed or disagreed with a policy or law.

In both the corporate and government systems of market research, the information collected, correlated and analyzed has been predominantly of a quantitative and socio-demographic nature (e.g., tabulations of how many Yes/No, ticks or crosses in the boxes, name, date of birth, gender, marital status, occupation, address, education level, size of family, household income levels, publications read, number of household goods bought, household expenditure levels).

In 1932, the organizational psychologist Rensis Likert of Columbia University invented a ratings scale by which to further categorize responses to paper-based market research surveys: 1=strongly disagree, 2=disagree, 3=neither agree nor disagree, 4=agree and 5=strongly agree. Thereafter, market research surveys changed from being close-ended, binary, thumbs-up-thumbs-down-thumbs-sideways, “Yes/No” type questions to surveys that included Likert's scale as a range of five options for the survey respondent. For example, instead of the question, “Do you like Product X?” which oriented and restricted the respondent to a “Yes/No” input, the Likert-based question became, “On a scale of 1 to 5, how much do you disagree or agree with this statement. Product X is something I buy,” and expanded the number of the respondent's options for answering the question from two to five. The Likert scale is the basis of the 5-star ratings systems widely deployed in ratings and reviews to be found on Amazon, eBay, Netflix, Wikipedia, Yelp and many sites across the Web.

Twenty-five years later, market research got another ratings system when, in 1957, Charles E. Osgood, Professor of Psychology at the University of Illinois at Champaign-Urbana, invented a semantic differential scale by which to measure the connotative meaning of objects, events, and concepts. The connotations were then used to derive the attitude towards the given object, event or concept. Osgood's semantic differential scale involves an adjective pair, e.g., hot-cold, and a 1 to 10, 1 to 100 or 1 to 100% gradation between these two polar opposites. So 1=cold and 10=hot (or 1=cold and 100=hot or 1%=cold and 100%=hot) and survey respondents select a point between 1 to 10 (or 1 to 100 or 1 to 100%) on the scale according to how much closer to cold or hot they think and feel the object, event or concept is.

In 1980, the psychologist Robert Plutchik, Professor Emeritus at the Albert Einstein College of Medicine, postulated an 8-part Wheel of Emotions scale for measuring people's emotional responses to items. This has added to market surveying methods. Plutchik's model presents itself as an 8-petal flower with 3 concentric circles containing 8 advanced emotions that are comprised of 2 basic emotions. Each petal is colored, clock-wise: North 0°=yellow; North-East 45°=light green; East 90°=dark green; South-East 135°=blue; South 180°=purple, South-West 225°=pink; West 270°=red; and North-West 315°=orange. The 8 advanced emotions and their 2 constituents are: love (joy and trust); submission (trust and fear); awe (fear and surprise); disapproval (surprise and sadness); remorse (sadness and disgust); contempt (disgust and anger); aggressiveness (anger and anticipation) and optimism (anticipation and joy).

Also in 1980 James A. Russell, Professor of Psychology at Boston College, published his Circumplex Model of Affect, which provided regression weights for 28 affect words as a function of pleasure-displeasure (x-axis) and degree of arousal (y-axis) that informs a user's behavior. These 28 affect words are listed in more detail in paragraph [0056]. Since its publication, Russell's circumplex model has also contributed to the design and methodology of market surveys.

Separately, and around the same time, Daniel Kahneman, Professor Emeritus of Psychology and Public affairs at Princeton University, published his and Amos Tversky's work on prospect theory and behavioral economics. This included surveying for human behavior that challenged the 1738 ideas from Daniel Bernoulli that we think in logical, rational and probabilistic ways when presented with choices—in his ‘Exposition of a New Theory on the Measurement of Risk’ which is the basis of modern-day economic methods for measuring risk aversion, risk premium and consumption utility. A sample Kahneman survey question was: “Choose between (A.) Getting $900 for sure or (B.) 90 percent chance of getting $1,000” and then “Choose between (A.) Losing $900 for sure or (B.) 90 percent chance of losing $1,000.” Kahneman's research pointed to human decisions and behavior being influenced by factors such as intuition, biases and the framing of the survey question; this led to them not choosing answers in a logical, rational and probabilistic way.

Another emotion-related model that has been used as a basis in market research, data analytics and Artificial Intelligence is Klaus Scherer, Professor of Psychology and director of the Swiss Center for Affective Sciences in Geneva's, Component Process Model for emotions which has been developed from 1984 onwards. It plots 100 emotions along the x-y axis whereby the negative x-axis on the left side is labeled “Positive”, the positive x-axis on the right is labeled “Negative”, the negative y-axis is labeled “Active-Aroused” and the positive y-axis is labeled “Passive-Calm”. Subsequently, in 2005, Scherer wrote about alternative dimensional structures of the semantic space for emotions and plotted the 100 emotions over 8 segments in a pie diagram with the axis labeled such that, clockwise from 0°: North 0°=Active/Aroused; North-East 45°=Obstructive; East 90°=Negative; South-East 135°=Low Power/Control; South 180°=Passive/Calm; South-West 225°=Conducive; West 270°=Positive; North-West 315°=High Power/Control. The 100 emotions used in Scherer's model are listed in depth in paragraph [0057].

More recently, in October 2013, Stanford University researchers published their Sentiment Treebank scale, which extended Likert's 5 options scale to their 7 options (from left to right: very negative, negative, somewhat negative, neutral, somewhat positive, positive, very positive) for users to rate movies and combinations of words such as “nerdy folks” and “phenomenal fantasy best sellers”. Additionally, instead of the “click the radio button/push the button” user interaction that commonly accompanies the Likert scale, the Stanford Sentiment Treebank scale is presented as a slider which users can drag left or right with their computer mouse. Notably, according to the Stanford Sentiment Treebank website, “Sentiments are rated on a scale between 1 and 25, where 1 is the most negative and 25 is the most positive.” Separately, a December 2013 method published by the Cognitive Neuroscience school at Finland's Aalto University School of Science showed their approach and results for measuring how the human body experiences 13 basic and complex emotions (anger, fear, disgust, happiness, sadness, surprise, neutral, anxiety, love, depression, contempt, pride, shame and envy) with a scale ranging from −15 to +15 and that contained these intervals: −15 to −10=aqua colored; −10 to −5=royal blue colored; −5 to +5=black colored; +5 to +10=red colored; and +10 to +15=yellow colored.

The Likert scale, Osgood's semantic differentials, Plutchik's Wheel of Emotions, Russell's Circumplex Model of Affect, Daniel Kahneman's prospect theory framework and Scherer's Component Process Model for emotions and other sentiment/mood measuring methods are explained in some detail to contrast prior art systems and methods built with those as a basis—including Stanford's Sentiment Treebank, Microsoft's Moodscope and BehaviorMatrix—from the system and method disclosed herein which uses a novel Perception pH® scale and its 8 rating spheres.

Since their inventions, the Likert and Osgood scales have been widely adopted in market research systems as categorization methods for survey responses. From 1962, the Likert and Osgood scales have also been applied in personality and psychometric-based market research surveys such as Myers-Briggs® (MBTI®), Belbin®, Enneagram and Saville-Holdsworth.

The advent of the Internet in the late 1990s and early 2000's led to market research methods being adapted into online systems. Pen and paper surveys became less used. Instead, market research was conducted via the following mechanisms: clicks of the mouse, detecting mouse activity over screen pixels, cookies in the Web browser; “push the button”, “tick the box”, “cross the box”, binary Yes/No options and pre-limited multiple choice radio buttons and dropdown systems to collect user's selections; online survey panels; popup polls and questionnaires; and in the input text boxes of message boards, commenting systems and customer feedback panels.

The Internet enabled market research to be collected on an industrial scale, more frequently and over a much shorter time periods than the government censuses with their ten year periods and months for respondents to send back their paper forms. Examples of companies that do Internet-based market research includes Nielsen, WPP, IPSOS, YouGov, SurveyMonkey, Harris Interactive, eOpinions, eRewards Inc. and Comscore.

However, even as the collection and distribution medium changed from pen and paper to online, the format structure of those prior art market research systems and their methods has stayed the same. The information collected, correlated and analyzed has continued to consist of quantitative, socio-demographic and psychometric categorizations based upon the frequency count of click responses, binary Yes/No (i.e., thumbs-up-thumbs-down, vote-up-vote-down), number of boxes ticked, number of boxes crossed, radio button and dropdown box selections, number of characters inputted into text boxes, and the Likert and Osgood scales.

Examples of online frequency count of responses are in link clicks and cookie logs of occurrences of browser activity across the Web such as by DoubleClick, acquired by Google in 2007. Examples of online thumbs-up-thumbs-down (vote-up-vote-down) are found in Hot or Not, Reddit, Diggit, and Facebook's “like”, Google's+1, Twitter's “tweet” and Quora's “vote-up” buttons.

Online examples of the Likert scale of 1 to 5 is found in the 5-star ratings system of market research, review and feedback systems of websites including Amazon, eBay, Yelp, TripAdvisor, Netflix, Apple App Store, Airbnb, WPP research panels, eRewards Valued Opinions panels, YouGov surveys, GoPollGo, Google Consumer Surveys, GfK surveys, Pew surveys, SurveyMonkey, McCann Erickson and other advertising agencies research, Alatest consumer electronics reviews site and other company websites in sectors ranging from finance to consumer products to leisure & travel to pharmaceuticals & healthcare and media. Online examples of the Osgood semantic differential scale are found on dating sites including Match.com and psychometric surveying sites including MBTI®, Keirsey and Enneagram.

Progressively, the data collected online also includes: the speed of clicks, the frequency occurrence of an item searched (e.g., by Google search and Microsoft Bing search), number of items purchased (e.g., eBay-Paypal and Amazon), $ value of items purchase, number of social connections (e.g., Facebook and LinkedIn), topics of interest (e.g., Twitter and Pinterest), geolocation-based data (e.g., Google Maps, Foursquare “check-ins”), number of social connections, number of “likes” and “friends”, “+1” and “shares”, “retweets” and “followers” (e.g., on Facebook, Google Plus and Twitter respectively), the tracking of mouse activity over screen pixels (e.g., Chartbeat, Mixpanel and SAS Customer Intelligence), structured semantic tags (e.g., by Google search, Powerset acquired by Microsoft in 2008 and integrated into Bing search, TEMIS), sentiment analytics where text inputted across social media platforms is parsed for emotions and brand reputation mining on a lexical basis (e.g., by Radian6, Viralheat, Jabfab, Twitrratr) and Quantified Self and emotional/mood analytics (e.g., Lift, Fluxstream, M.I.T.'s Moodmeter). Yet another type of data collected online has been the frequency counts of #hashtags, popularized on Twitter, Facebook and Google+ such as #adjective, #noun, #verb and any combination of #adjectivenounverb.

However, the forms of the data collected online listed above don't have explicit directional orientations (e.g., negative, neutral, positive, dual) or the intensity of the directional orientation for the data. This means that when Machine Learning and Natural Language Processing tools are applied to parse for the data's meanings and to conduct quality control of the data set, these tools can only apply fuzzy logic and probability to do a frequency count of the data item or #hashtag's occurrence and then to infer for directional orientation according to some of the lexical databases referenced in paragraph [0044]. Therefore, prior art has well-known difficulties in accurately parsing the data item or #hashtag's directional orientation and is less able to disambiguate the intensity of the directional orientation for the data item in a precise and coherent way.

With the launch of smartphones like the iPhone in June 2007 and mobile tablet devices like iPad (Apple iOS) in April 2010, Google Nexus and Samsung Galaxy (Google Android OS) in 2010 and Surface Pro (Microsoft Windows 8 OS) in February 2013, market research moved from online systems to mobile systems.

However, even as the collection and distribution medium changed from online to mobile, the format structure of these market research systems and their methods stayed the same. The information collected, correlated and analyzed also continued to be of quantitative, socio-demographic and psychometric categorizations based on the frequency count of responses, binary Yes/No (i.e., thumbs-up-thumbs-down, vote-up-vote-down) options, number of boxes ticked, number of boxes crossed, dropdown selections, and the Likert and Osgood scales.

Examples of mobile surveys using these legacy systems and methods of market research include Opinionmeter, SurveyPocket, Research Now's Valued Opinions, Milk's Oink (acquired by Google in March 2012), Facebook Places, Livestar, Amen (acquired by tape.tv in August 2013), Thumbspeak, Alike, HeyCrowd, Techneos, Crowdtap, PowerReviews and a number of dating apps including Hinge, Tinder and Match.

In attempts to collect data of a more qualitative and emotion-based dimension, Web and mobile survey methods have started to include buttons labeled with an emotion which users can push, emoticons, dropdown options and text input boxes into which users can input a status update on how they're feeling. Examples of these can be found in mood applications including Facebook Moods, My Mood Tracker, Expereal, Emocube, T2 Mood Tracker, WeFeelFine, M.I.T.'s Moodmeter, Emotion Sense, and Microsoft's MoodScope. It is also used in the reviews and user feedback mechanisms of well-known consumer sites, such as: Yelp has “useful”, “funny” and “cool” buttons in its user comments sections; Buzzfeed has “LOL”, “win”, “omg”, “cute”, “trashy”, “fail” and “wtf” in its comments section; AirBnB has a dropdown of “panicked”, “upset”, “worried”, “confused”, “curious”, “optimistic” and “unsure” in its Contact AirBnB Help Center section to collect “How do you feel right now?” inputs from users; Huffington Post had a Reactions bar which contained “inspiring”, “funny”, “obsolete”, “scary”, “must-have”, “amazing”, “innovative” and “nerdy” at the top of each article to collect feedback on reader's opinions about the article; and Wikipedia had buttons labeled “helpful”, “useful” and “okay”.

Additionally, Russell's 1980 Circumplex Model of Affect was used as a basis to survey for people's moods over time and compare it with their smartphone usage in Microsoft's Moodscope mobile application published in June 2013. Microsoft's Moodscope's defines 8 mood segments: excited, happy, relaxed, calm, bored, upset, stressed, tense along a Pleasure x-axis and an Activeness y-axis. Meanwhile, in February 2014, BehaviorMatrix LLC disclosed that its model for classifying, measuring and creating models of the elements that make up human emotions, perceptions and actions leveraged from the Internet and social media is inspired by Plutchik's Wheel of Emotion methods.

Unlike these prior art emotion-based systems and methods, the system and method disclosed herein is for perceptions as described in detailed examples in paragraph [0058] and from paragraphs [0078] to [0175]. It has its own novel Perception pH® scale and 2TOUCH™ data collection approach.

The advent of a growing interest in behavioral data, influenced by Kahneman's work referred to in paragraph [0013], meant that Web and mobile sites started to collect and track where a user clicks on a web page or touches in a mobile application, the length of time they stay on a web page or interact with each component of a mobile application, the frequency of times they log-in, how long their comments are, the $ amount of applications they download, how many devices they buy, geo-location of where they are when they activate on or interact with their mobile device, number of social connections they make, where and how many times they check-in, length of time they watch a video, how many adverts they skip. Examples of prior art applying behavior analysis include systems for inferring user intent, spam filters, analyzing shopping choices, object identification, content discovery, prioritization and recommendations, and brand management for social networks. The system and method disclosed herein starts with people's perceptions and their qualitative and quantitative dimensions rather than with the quantities of people's behaviors.

Another type of data collected about users via mobile devices has been achieved through on-board sensors in devices from mobiles to video cameras to “Internet of Things” devices and neuroheadsets that can measure brain activity. The data is of a quantitative type, i.e.: frequency count of “On/Off/Pause” activation of the device and its applications; geolocation data to detect the user's longitude, latitude and altitude (e.g., by Foursquare, Gowalla and Instagram acquired by Facebook, Life360, Shopular, Highlight and Path applications); chipset sensors which can measure ambient temperatures, pitch and amplitude levels in audio-voice recognition around the mobile device via its microphones, the heartbeat pulses of the user and the pressures, temperature and other biometrics of the user's touch on the mobile device's screens and buttons; visual object, color and focus detection via the camera feature of the mobile device; the angles of momentum of gyroscopic tilts within the mobile device; motion gestures such as in Qualcomm and Intel Perceptual Computing chipsets; in-vehicle sensors like GPS detectors; and the speed and distance at which the device moves captured by the device's accelerometer. Collectively, these systems and methods of market research are widely known as “sensor-based capture”.

Examples of sensor-based data capture include the iPhone's gyroscope and accelerometer, Qualcomm's Gimbal chipset for mobile devices, Nest thermostat (Nest was acquired by Google in January 2014), Microsoft Kinect, Sphero, Google Nexus Q, Withings smart scale, Intel Perceptual Computing screen and infrared devices, Scanadu Tricorder for measuring health-related conditions and wearable technologies such as: Google Glasses, Apple iWatch, FitBit Ultra, Nike Fuelband and Jawbone's Up wristbands, Nike+ Training and Nike Hyperdunk+ smart sensor shoes and Misfit Shine button. Examples of sensors being applied to measure user emotions, moods and other affective behavior include Intel's Perceptual Computing system, Affectiva's Facial Expression Analysis system, Emotiv's neuroheadset for conducting electroencephalography (EEG) on brain activities; Interaxon's brainwave-sensing headset; Beyond Verbal's emotion-decoding voice recognition system and Microsoft's emotion-sensing Kinect system.

Such sensors involve the measurement and conversion of physical phenomena into analog and/or electrical signals and their examples include: audiovisual sensors for measuring and recording the user's sounds and images; barometric pressure sensor for measuring atmospheric pressure, e.g. in determining altitude and weather conditions; accelerometer to measure the direction of gravity, linear and/or angular motion, tilt and/or roll and any other force experienced by the sensor; gyroscope which measures the Coriolis effect, e.g. for gauging directional changes or rates of rotation in the field of navigation; magnetic field sensor as in the use case of a compass for determining directionality in car and pedestrian navigation applications; biometric sensors that might include heart rate monitors, blood pressure monitors, fingerprint detection, touch (haptic) sensors, blood sugar (glucose) level measuring sensors, and so on. In combination, the above prior art sensors aim to provide adequate degrees of observability of physical phenomena in a quantified way.

This patent application, though, is for a system and method that provides directional orientation and degree/extent of observability for the perceptual and behavioral phenomena of people in a qualitative and quantitative way.

Regardless of whether market research has been collected via paper, Web-mobile-smart TV based devices or sensors, the focus on collecting a high quantity of data rather than on the data's qualitative dimensions and dynamics has affected the analytics engines (probabilistic, sentiment and semantic) and recommendation systems of prior art. The high quantity of data means the volumes of binary Yes/No, Likert scale, Osgood scale, socio-demographic, psychometric (including those based on Myers-Briggs® personality and Plutchik's, Russell's and Scherer's methods for measuring emotions, moods and affective psychology), behavioral (including of the Quantified Self-type, explained in more detail in paragraph [0059]) and quantitative data has fitted conveniently with probabilistic, statistical and logic-based programming to generate the closest proximity, highest possible correlations and “edges” between one data object to another with the lowest squared errors. From these analytics, lists and clusters of correlated objects have been produced and served to the survey's user as recommendations in paper reports and via Web-mobile-smart TV devices.

Despite the volume and variety of data now being collected and correlated, it should be noted that it's widely accepted correlation is not the same as or directly equivalent to causation. Correlation is a measure of quantity. Causation may be a synergistic force of compound qualities, e.g., “That product's magical to use, reasonably-priced, great as gifts for family and friends and was convenient to buy where I was so . . . I bought three of them!” or “I ran 10 miles in those trainers because they're so comfortable, light and springy!”

Causation dynamics in consumption matters because it could lead to the smarter allocation of resources and the better management of financial and other risks. Unfortunately, legacy systems of market research has produced data sets which are quantitative but not sufficiently qualitative to enable data analytics to be conducted such that it benefits and supports consumers, companies, governments and societies with more informed decision-making.

Increasingly, over the recent decade, data analytics have been collected, analyzed and generated via Artificial Intelligence, Neural Networks and Machine Learning processes. More and more data sets have been accessible via publicly available APIs such as Facebook, Google Maps, Microsoft Bing, Twitter, Yahoo BOSS, Wikipedia, eBay, Amazon, Pinterest, Etsy, Yelp, TripAdvisor, Netflix, last.fm, Twilio, Soundcloud, Salesforce, YouTube, Bit.ly and others, for analysis in a “Big Data” way and in the creation of graphs such as “Social Graph”, “Knowledge Graph” and “Interest Graph”. The addition of sensor-based data increases the number of probabilistic calculations and correlations that can be conducted on these huge quantities of data. However, whilst current machine intelligence is set-up to quickly process large quantities and the probabilistic correlations between each data entity, it should be borne in mind that machine intelligence struggles with parsing and understanding qualitative data including emotions, subjunctive tenses, cultural nuances and double entendres. This qualitative data contains perceptual factors that the system and method disclosed herein is designed and developed to deal with unlike prior art.

Moreover, the speed frequency of processing power enabled by “Big Data” systems on the volume of data is not the same as the systems being sufficiently intelligent to understand and map the velocity, veracity, variety, variability, viscerality, versatility and value of the data. Therefore it's necessary to evolve machine intelligence systems to enable them to comprehend and cohere qualitative data entities as well as quantitative ones from point of data collection in market research through to data analytics via machine intelligence means and through to recommendations and visualizations of the data as outputs.

Prior art recommendation engines have been based on collaborative filtering such as by Amazon, eHarmony and Infosys, social connections such as by Facebook, LinkedIn and Yahoo, keyword frequencies such as by Google, geo-location such as by Foursquare and Microsoft, content-based filters such as by AOL Inc., IMBD, Pandora Radio and Sony Ericsson AB, hybrid filters such as by Netflix, and behavior-based analytics such as by Amazon. This system and method generates recommendations based on people's perceptions rather than what prior art does.

Historically, various attempts have also been made in semantic and sentiment analysis systems working on data collected via legacy market research systems. As an example of how prior art semantic and sentiment approaches fail to capture the viscerality and versatility of a data object, the word “green” has multiple interpretations and connotations beyond its current literal semantic and sentiment definitions. Semantically, its metatag refers to it as a color and these metatags are counted for their frequency of occurrence and probabilistic correlations by “Big Data” algorithms. Meanwhile, the sentiment representation of “green” is as a positive state (thumbs-up, binary 1) with “red” as a negative state (thumbs-down, binary 0): this accords with the traffic lights designation of “green for go” (thumbs-up) and “red for stop” (thumbs-down). However, on a visceral level, green has positive connotations of “fresh” (lush green valleys) and “fortuity” (in Chinese culture, green is a lucky color) whilst on a versatility level green also has negative connotations of “envy” (like the green face of the Wicked Witch of the West in the ‘Wizard of Oz’ movie), “anger” (the Hulk turns green with rage) and “inexperience” (green about the gills). Those are just some examples of current “Big Data” and machine intelligence approaches not being adequate enough to deal with the quality dimensions of data even when they may be appropriate for dealing with the quantity volumes of data collected via legacy market research systems.

Unfortunately, with regards to prior art in semantic analysis, there are also limitations in the specifications of item identity structures. They're primarily lexical, noun-based and cover metadata of the following types: CreativeWork (e.g., genre, publisher, contentSize), Event (e.g., attendee, duration, performer), Intangibles (e.g., description, images, url), MedicalEntity (e.g., guideline, medicineSystem, recognizingAuthority), Organization (e.g., contactPoint, employees, foundingDate), Person (e.g., affiliation, birthDate, nationality), Place (e.g., address, geoCoordinates, interactionCount), and Product (e.g., brand, itemCondition, manufacturer). Moreover, during Natural Language processing the semantic structures used are of the form <subject><predicate verb><object> in order to train the machine to parse sentences for meaning and to assign action attributes between the subject and the object. However, the meaning of words and sentences require more than the recognition of the nouns of subjects and objects and the actions between them, and the relationships between nouns and verbs as prior art does. Being able to understand meaning from content requires the ability to categorize and evaluate each word text or audiovisual for its directional orientation (negative, neutral, positive or dual), the degree/extent of that orientation (−N through 0 to +N) and the connotative associations of the word text or audiovisual; and the system and method disclosed herein is designed for this. Other limitations of prior art in semantic analysis involves issues concerning the vastness of the Web and its data pools, the vagueness of imprecise data entities like “green” and “mean”, the uncertainty of precise data such as weather variability, inconsistency in ontologies (e.g., cultural differences and lost in translations), and intentional deceit where the person(s) tagging a semantically-structured web page does so in order to “game” search engine listings for example.

Moreover, with regards to prior art in sentiment analysis, the typical lexical implementations mean that the adjectives collected from across social media streams are compared and processed, by Natural Language programs, against reference sentiment dictionaries and lexical databases such as: Harvard General Inquirer, which originated in 1961 as an IBM 7090 program system containing opinion polarity, specified as “directional orientations”, restricted to two binary states: “negative” and “positive”, and two binary states of intensity of “weak” and “strong”); University of Pittsburgh's Subjectivity Lexicon based on the 2005 publications of Theresa Wilson, Janyce Wiebe, and Paul Hoffmann; LIWC (Linguistic Inquiry and Word Count (LIWC) software program designed by James W. Pennebaker, Roger J. Booth, and Martha E. Francis released in 2007; and Princeton's WordNet® which has its origins in George A. Miller's 1995 publication ‘WordNet: A Lexical Database for English’; generative semantic and syntax frameworks based on the work of Noam Chomsky, Professor of Linguistics (Emeritus) Linguistic Theory, Syntax, Semantics, Philosophy of Language of Massachusetts Institute of Technology (M.I.T.), such as the Brandeis Semantic Ontology. Semantic frameworks for Neural Networks in AI have also used methods and frameworks provided by Marvin Minsky, co-founder of M.I.T's Artificial Intelligence Lab, and separately Scherer's Component Process Model of emotions referred to in paragraphs [0014] and [0057].

The limitations of these reference sentiment dictionaries and lexical databases include the directional orientations being biased and restricted to the opinions of the person(s) who pre-set the classifications of the sentiment, the profusion of informal and spoken words which the dictionary creator(s) are not knowledgeable about but which are used across social media, the lack of human agreement about a word which results in low latency and low recall amongst diverse cultural populations, and the dictionaries not being updated on a timely basis to include new word inventions.

The limitations of prior art in commerce (herein this term encompasses mobile, retail and Web-based commerce), market research, personality and psychometric tests, data analytics (including probabilistic, semantic and sentiment), Web-mobile-smart TV surveys, ratings, reviews and recommendation systems, Artificial Intelligence and human-machine intelligence described above are overcome by the system and method disclosed herein.

### SUMMARY

This system collects, categorizes, coheres and generates qualitative information about items—specifically relating to people's perceptions of those items—so that it can be combined and connected in a coherent way with quantitative, socio-demographic and sensor-based biometric data to build perception profiles of people and their consumption behaviors, and to generate recommendations based upon people's perceptions.

In contrast to prior art, it is the qualitative data in coherency with quantitative data that this system and method has specifications to collect, calibrate, process and output. Instead of prior art's over-dependence on fuzzy machine logic and probabilistic correlations and statistics to parse for human ambiguities of meaning and intent to buy, this system sets out specifications that enable users to directly input their perceptions and intents about items and applies its own frameworks for Artificial Intelligence and Machine Learning on those inputs.

Prior art approaches in Artificial Intelligence includes Google Brain, IBM Watson and Apple's SIRI. Their basis is that of probabilistic and statistical frameworks such as: Bayesian inference, discrete-time Markov chains, hierarchical temporal memory cortical learning, non-linear recursive learning with Gaussian processes, adaptive lag, Boltzmann machine, k-nearest neighbor, Natural Language, knowledge representation ontologies, Kalman filters, Random Tree, back-propagation, kernel method classifiers, cellular automata, game theory, utility theory, latent semantic analysis. As a discipline, AI originated from Alan Turing's seminal 1950 paper, which posed the question “Can machines think?” and provided his “Imitation Game” framework to test for machine intelligence, known as the “Turing Test”. The Probability methodology applied in prior art have their origins in the invention of Probability by Blaise Pascal and Pierre de Fermat in 1654 during a gambling game involving cards, dice and coins. Notably, the system and method disclosed herein originates from the basis of perceptions and as they affect the human brain and enable us to make sense of choices and decisions rather than from the basis of probability as it affects cards, dice and coins in accordance with Pascal-de Fermat's methods. Specifically, this system and method makes the assumption that perceptual calibrations in our brain's decision-making process are not necessarily of a quantitative, logical, rational and probabilistic amount first—rather that perceptions of quality and quantity, directionality and the degree/extent of that directionality informs our mind and affects our decisions; and perceptions are a priori to any frameworks and calculations of probability and statistics.

Moreover, this system processes perceptions not simply as data entities that can be correlated for probability and proximity of relationships or “edges”, but also perception as data entities of causation and drivers of people's consumption behaviors. For example, an intensely negative perception can cause the consumer to not buy into the good, service, content, relationship or experience on offer whilst an intensely positive perception can cause the multiple and excess buy into a good, service, content, relationship or experience. This consumer perception is individualistic and independent of what the consumer's peer social groups may think and feel about the item and the perception is also independent of product utility, price, location convenience and availability of the item. It includes the intuitive causes of their consumption as much as their rational considerations about price correlations, availability at places, time context and quantity-based comparisons.

Instead of prior art's legacy survey formats of “push the button”, “tick the box”, “cross the box”, binary Yes/No, vote-up-vote-down mechanisms and pre-limiting multiple-choice options with radio buttons and dropdowns for users to select which carry the biases of the survey designer and which are manifest whether the survey is delivered via the Web browser or as a mobile application, this system uses (click or touch) drag-and-drop mechanisms for user's selection of multiple options. Options are partly generated by the system and also partly self-inputted by the user.

Notably, this system's 2TOUCH™ survey process using (click or touch) drag-and-drop is consistent in its UI and user experience whether it is delivered via the Web or mobile browsers on the Web, mobile or smart TV devices. It operates with cross-platform and cross-media functionality across client devices. This is different from prior art, which has separate UI and user interactions when on the browser compared with when on the mobile device, across various browsers and a range of screen sizes.

Unlike prior art's vote-up-vote-down, 5-star ratings, frequency count of clicks, tracking of mouse or touch activity on the screen, cookie tracking in browsers, Likert 5-option and Osgood semantic differential scales and frequency counts of emotion-worded buttons and emoticons which have underpinned market research systems and methods to-date, this system and method categorizes user inputs of survey responses according to various embodiments, including and not limited to: directional orientation (e.g., negative, neutral, positive, dual); numerical value which indicates the intensity of the orientation (−N to 0 to +N, −N % to 0% to +N %); gender (e.g., male, female, neutral, dual); color value (e.g., red=most negative, orange=more negative, yellow=negative, green=neutral, blue=positive, indigo=more positive, violet=most positive, and any combination of RGB=directional orientation); word associations (e.g., adjectives, adverbs, nouns, verbs, cultural identity and action orientation such as: sell (negative), hold (neutral), buy (positive); age of comprehension level (e.g., 0-2 years, 3-4 years, 5-8 years, 9-11 years, 12-16 years, 16+ years, degree-level and professional-technical); and any combination of these.

Unlike the Likert and Osgood scales which are restricted to the positive, real end of the number scale (Likert goes from 1 to 5 whilst Osgood has gradations from 1 to 10, 1 to 100 or 1 to 100% points), this system's novel Perception pH® scale is more flexible and spans the number scale from −N to 0 to +N, where N is a number or a percentage; moreover, this provides both directional orientation as well as the intensity of orientation for the item being surveyed. Perception pH® acts as a calibrator and signal tuner for people's perceptions about any item.

Unlike Plutchik's Wheel of Emotions and other prior art systems and methods to collect and measure moods, emotions and sentiments, this system and method is for collecting, measuring and understanding perceptions via its Perception pH® scale. Examples of emotions are: affection, anger, angst, anguish, annoyance, anxiety, apathy, arousal, awe, boredom, confidence, contempt, contentment, courage, curiosity, depression, desire, despair, disappointment, disgust, distrust, dread, ecstasy, embarrassment, envy, euphoria, excitement, fear, frustration, gratitude, grief, guilt, happiness, hatred, hope, horror, hostility, hurt, hysteria, indifference, interest, jealousy, joy, loathing, loneliness, love, lust, outrage, panic, passion, pity, pleasure, pride, rage, regret, relief, remorse, sadness, satisfaction, self-confidence, shame, shock, shyness, sorrow, suffering, surprise, terror, trust, wonder, worry, zeal, zest; and their associated adjectives—affected, angry, antsy, annoyed, anxious, apathetic, aroused, awed, bored, confident, contemptuous, courageous, curious, depressed, desirable, despairing, disappointed, disgusted, distrusting, dreadful, ecstatic, embarrassed, envious, euphoric, excited, fearful, frustrated, grateful, grief-stricken, guilty, happy, hateful, hopeful, horrified, hostile, hurtful, hysterical, indifferent, interested, jealous, joyful, loathsome, loving, lustful, outraged, panic-stricken, passionate, pitiful, pleasurable, proud, raging, regretful, remorseful, sad, satisfied, self-confident, shameful, shocked, shy, sorrowful, suffering, surprised, terrified, trusting, wonderful, worried, zealous and zestful.

Whilst Plutchik's Wheel of Emotions model contains 8 advanced emotions and their 2 constituent emotions resulting in 16 emotions, Russell's Circumplex Model of Affect has 28 affect words categorized into 4 quadrants over the x-axis of pleasure-displeasure and the y-axis of degree of arousal. These are, clockwise: positive-x-positive-y quadrant (7 affect words)—astonished, excited, aroused, happy, delighted, glad, pleased; positive-x-negative-y quadrant (8 affect words)—content, satisfied, at ease, serene, calm, relaxed, tired, sleepy; negative-x-negative-y quadrant (6 affect words)—miserable, sad, depressed, gloomy, bored, droopy; negative-x-positive-y quadrant (7 affect words)—alarmed, afraid, angry, frustrated, tense, annoyed, distressed.

Meanwhile, Scherer's Component Process Model of emotions puts 100 emotions onto an x-y graph such that: positive-x-positive-y quadrant (20 emotions)—bellicose, hostile, hateful, envious, defiant, enraged, contemptuous, angry, jealous, disgusted, indignant, loathing, discontented, impatient, suspicious, bitter, insulted, distrustful, bored, startled; positive-x-negative-y quadrant (21 emotions)—disappointed, apathetic, dissatisfied, taken aback, worried, uncomfortable, feel guilt, despondent, languid, ashamed, desperate, embarrassed, melancholy, wavering, lonely, hesitant, anxious, sad, dejected, insecure, doubtful; negative-x-negative-y quadrant (20 emotions)—feel well, impressed, amorous, astonished, confident, content, hopeful, relaxed, longing, solemn, attentive, pensive, contemplative, friendly, polite, serious, peaceful, conscientious, empathic, reverent; negative-x-negative-y quadrant (19 emotions)—adventurous, lusting, triumphant, self-confident, ambitious, conceited, courageous, feeling superior, convinced, enthusiastic, elated, light-hearted, determined, amused, excited, passionate, joyous, interested, expectant.

Examples of perceptions, which are what the system and method disclosed herein are about, include the assignment of adjectives and connotations such as abloom, brilliant, coherent, decisive, extensive, fast, geometric, helpful, ingenious, jazzy, kaleidoscopic, light, meaningful, nuanced, observant, personalized, quick, reliable, solid, two-sided, ubiquitous, viral, worldly, xenial, yielding and Zen to something. Perceptions go beyond emotions and also encompass sizes, shapes, colors, textures, “look & feel”, tastes, smells, temperatures, amplitudes, attitudes and other sensory attributes from vision, hearing, touch, taste and smell.

The measurement of perceptions via the system and method disclosed herein is also different from the data measured in Quantified Self surveying systems and methods. Those are designed to capture the quantitative data of the type: Physical Activities—calories, metabolic burn rate, miles, repetitions, steps, velocity; Diet & Nutrition—calories consumed, carbohydrates in grams, cost, fat protein, glycemic index, ingredients, protein, satiation, size of portions, supplement dosages, tastiness; Psychological, Mental & Cognitive State & Traits—alertness, anxiety, attention (selective/sustained/divided), confidence, creativity, depression, emotion, esteem, focus, happiness, IQ, irritation, memory, mood, patience, psychomotor vigilance, reaction, reasoning, verbal fluency; Environmental—architecture, clutter, light, location, noise, pollution, season, weather; Situational—altitude, context, gratification of the situation, position, time of the day, day of the week; and Social—charisma, clout, influence, power, role/status in social circle, trust, wealth.

Another advantageous difference from prior art is that this system and method enables the user to freely assign items with a Perception pH® value of their choice rather than being limited to the biases of the survey designers in the way that prior art systems are. They impose categorizations of user responses as “negative” or “positive” whereas this system adopts a different method. For example, prior art market surveys may categorize the word “cool” as positive on their limiting Likert or Osgood-type scales because the designer's lexicon was based on the cultural influences of their Western heritage. In this system, one user may assign a Perception pH® value of +2 to “cool” whilst another user assigns it a −1 because the first user is American, of a younger generation, uses the term regularly and associates with the word laterally whilst the second user is Chinese, of an older generation, uses the term infrequently and associates with the word literally to mean “a colder temperature”. Therefore, this system and method provides the user with more flexibility regarding how they evaluate an item and with more man-machine interpretation options.

With regards to sensor-based capture, which is understood by anyone skilled in the art, this system is distinctive in its sense-filtering and sense-making processes. Sense, as it relates to this system, is defined as the five physical functions of vision, hearing, smell, taste, and touch which can be collected via “sensor-based capture” plus sixteen sense-making functions related to the field of Neuroscience: cognition, collation, categorization, connection, comparison, conjugation, coalescence, prioritization, comprehension, contextualization, connotation, evaluation, coherence, creativity, culture and communication.

It is these sixteen Sense functions that the novel Perception pH® rating criteria in this system simulates and executes in its Artificial Intelligence and Machine Learning processes. They represent the way in which quantitative and qualitative information is filtered and combined across both the left side of our natural brains (logical, objective, rational, probabilistic, structured, technical, literal, self) and the right side of our natural brains (linguistic, subjective, emotional, perceptual, free association, intuitive, lateral, social) to enable our ability to process information, formulate relationships, make decisions and engage in our consumption behaviors. Independent of the system and method disclosed herein, in January 2014 Max Tegmark, Associate Professor of Physics at M.I.T., proposed a theory for the existence of Perceptronium (“the most general substance that feels subjectively self-aware”), and Computronium (“the most general substance that can process information as a computer”) which has implications for prior art assumptions that our brains are purely objective and that the information processing should follow logical methods. Notably, Tegmark's work does not describe a system or method by which to evaluate subjective self-awareness like this system and method disclosed herein does.

Moreover, in contrast with prior art in semantic and sentiment analytics with their lexical approaches, quantity count of incidences of the word appearing in the huge volumes of text and probabilistic correlations, this system applies Artificial Intelligence, Machine Learning, Neural Networks, Quantum Mechanics notation and semantic structures to parse, connect and cohere code structures of a qualitative and quantitative specification like this:

<subject | subjunctive_predicate_verb ∥
PerceptionpH_keyword:=descriptive ∥
object ∥ object_philia:= perceptual intensity or Perception pH | object>

and its variations and adaptations.

An example variation is:

<John | potentially loves to buy ∥ fast light (+2; +2) mobile phones ∥

excessively. >

In this way, this system enables the previously noun-and-verbs-only semantic tags to also embody Perception pH® tags. These Perception pH® tags are also complementary with the sentiment structures, EmotionML, proposed by W3C in its public working draft from 29 Oct. 2009 onwards. An example of EmotionML is this:

<emotion category-set=“http://www.w3.org/TR/emotion-voc/xml#big6”>

<category name=“sadness” value=“0.3”/>
<category name=“anger” value=“0.8”/>
<category name=“fear” value=“0.3”/>

</emotion>

Another way in which this system overcomes the limitations of prior art in semantic and sentiment analysis is that it enables users to evaluate items according to their own perceptions by selecting whichever Perception pH® values they want to assign to the item rather than be bound by what the prior art survey designer deemed to be as valuable (such as frequency counts and popularity votes), to input the user's own terms of dictionary reference rather than be restricted by prior art's narrow lexical dictionaries, to declare the user's own cultural influences rather than be confined by prior art's biases of what the survey designer defined as “negative” or “positive”, and to interact with the system on a real-time updating basis rather than prior art's static and fixed lexical libraries.

### BRIEF DESCRIPTION OF THE DRAWINGS

The drawings incorporated herein form part of the specifications and illustrate the diverse embodiments of the present disclosure. Together with the descriptions, they serve to explain the principles of the system and method such that any person skilled in the art would be able to make and use the system. However, it should be appreciated that the same principles are equally applicable and can be implemented if changes are made to the drawings. Any such variations do not depart from or reduce the true spirit and scope of the present system and method. In the drawings, like reference numbers indicate identical or functionally alike elements.

FIG. 1 is a flow diagram illustrating the different components of the system embodiment.

FIG. 2A is a flow diagram for the items to be surveyed and evaluated as they are processed through the system.

FIG. 2B is a flow diagram for the users to be surveyed and the creation, categorization and coherence of their User Profiles.

FIG. 3A is a schematic diagram of one implementation of the system's Client-Server-API-Cluster architecture.

FIG. 3B is a schematic diagram of sample database clusters components and their processes.

FIG. 4A is a method diagram of the legacy “Marketing Mix” which underpins prior art market research and data analytics systems; it combines the 4P method proposed by E. Jerome McCarthy in 1960 and its expansion into the 7P method of Booms and Bitner in 1981.

FIG. 4B is a method flow diagram for users (consumers and companies) in this system's market surveying as it relates to users' perceptions and purposes and how this system incorporates perceptions and purposes into its functional processes.

FIGS. 5A to 39 are example diagrams of the User Interface that appears on client devices and the (click or touch) drag-and-drop mechanisms of the present system.

FIG. 40 is a screenshot showing sample navigation overlay of the UI on a browser.

FIGS. 41A, 41B and 41C illustrate the embodiment of the rating component as a plug-in, as described in claims 17-18.

FIGS. 42 to 50 are example screenshots of the system's Output Analytics, Data Visualizations and Recommendations.

### DETAILED DESCRIPTION OF ONE OR MORE EMBODIMENTS

The following disclosures describe the principles, embodiments and functions of the present system and method. However, the disclosures should not be construed as being limited to particular embodiments described herein. They are provided on an illustrative rather than restrictive basis and it should be appreciated that variations of an electrical, mechanical, logical and structural type may be made to the embodiments, by anyone skilled in the art, without departing from or reducing the scope and spirit of the present system and method disclosed.

As shown in FIG. 1, this system focuses on the surveying and evaluation of items according to a user's perceptions, with a novel Perception pH® rating scale governing the evaluation processes intrinsic to the system and method. The system is a computer-based one wherein the components can be implemented in hardware, software, firmware and combinations thereof. The user can access the system via client computing devices such as those indicated by 101, including but not limited to: mobile tablet, desktop or notebook, smartphone and smart TV device.

Client devices communicate with the system's Application Server via security and encryption layers (not shown in diagrams) that are understood by anyone skilled in the art. The system has configurations for its processors, memory allocation and storage and database architecture that enable the functionalities and implementations described herein.

Client devices communicate with the system on an independent basis from each other and on a non-continuous basis. The former point reflects the fact that users may have different devices activated at the same time and each may not be logged into this system. The latter point reflects the fact that the user turns their client devices on and off at their own convenience, which may interrupt the data transmission between the client device and this system. The system can make available the last saved version of the data sent by the client device before it went offline, e.g., in airplane mode, for user interaction whilst the device is offline. Once the client device is online again, the system establishes instantaneous communication with the client device, asks the user if they want to update their information and processes whatever interactions the client has made relating to the system via their device whilst offline.

Although the processes and components described herein are labeled on a sequential basis, when the system is in operation the order of the sequences may vary depending on the client device involved, the items being evaluated and the user's personalization settings amongst other functional specifications. Moreover, it should be understood that the system's processes are configured to adapt to running on sequential, non-sequential, simultaneous, time lag-delay, parallel, adaptive learning and contiguous basis, and any combination of these that optimizes processing engine performance and flexible memory storage.

Since each of the client devices operate according to a set of algorithms, microprocessors and controller devices produced by the device manufacturer, the description of the processes and components of the system herein takes into account that changes to those third party algorithms, micro processors and controller devices may affect this system. Therefore, descriptions are provided on an “as is” basis with the understanding that the system's operations are not limited by the “as is” descriptions but adaptable to client device changes by third parties in the future.

Currently, these suites of algorithms, microprocessors and controller devices execute the instructions of readable data contained within a diverse range of known media. Known forms of non-transitory tangible computer-readable media which are covered and integrated into this system include, and are not limited to: hard disks, floppy disks, removable disks, magnetic disks, optical disks, USB drives, courier drives, DVDs, CD-ROMs, RAM, PROM, EPROM, FLASH-EPROM and any other memory chips or cartridge, media cards, tapes, drums, punched cards, paper tapes, barcodes, QR code, magnetic ink characters, and any other medium of data storage that a computer, processor or similar machine is able to read from.

Concrete examples of computer readable signals, whether carrier-modulated or otherwise, are ones that a computer system hosting or running this system can be configured to access. That is, this system is accessible via an Internet, mobile or other networks and executed upon downloading from the Internet, mobile or other networks.

Transitory propagating signals such as Wi-Fi, Bluetooth, GSM, CDMA, NFC, radio, microwave and other signals are explicitly excluded from the specifications in this disclosure.

In a similar way to the system not being limited by client device changes, it should be understood that the database architecture described in this disclosure is provided on an “as is” basis with the proviso that alternative database architectures may be deployed. These alternatives are necessary adaptations in response to constantly evolving market conditions and technological advances and it should be appreciated that these changes would not depart from or reduce the scope and spirit of the system and method disclosed.

For that reason, diagrams provided herein are for illustrative purposes rather than as de facto strict and limiting arrangements for the storage and processing of the data or any embodiment. Storage includes and is not limited to: Local Area Network (LAN) structures, Network Attached Storage (NAS), Cloud Clusters, P2P servers, Grid servers, Relational Database Management Systems (RDMS) such as SQL, NoSQL, XML databases, .txt files, distributed and non-distributed storage, and any other type of storage understood by anyone skilled in the art. Processing here refers to the machine execution of the programs within the system and to the (click or touch) drag-and-drop mechanisms of the data collection process.

Returning to FIG. 1, at the point of successful user login, 102, the system serves up a User Interface (UI) of a designed format—examples of which are shown in FIGS. 5A to 50. In tandem, the system accesses its pre-populated “Seed Databases” of items designated as suitable for user evaluation and the user is asked to either agree to or reject the items offered, 103.

If the user chooses to reject the items, the engine registers this and surfaces Personalization Panels from User Settings that allow the user to either select another set of items and/or use tools to search for items they wish to rate and/or self input items of their choice, 104. These user options are made within the parameters of the user's pre-selected topic clusters shown in FIG. 2B: 226.

Within the Personalization Panels, users can also select whether they want their item ratings to be publicly displayed, only viewable to select parties, kept private and/or anonymized. If the user opts for publicly displayed, their ratings will be portable across well-known social media communities. Users are able to change these privacy settings at their convenience.

During the fine-tuning of the data collection engine, diverse sets of items are retrieved from the databases, indicated by 105 and shown in more detail in FIG. 2A. The items appear in the Personalization Panels for the user's selection. Upon selection, items are registered into the database as time-stamped updates of the user's personal preference settings, 106. This Machine Learning loop in the process results in the system generating more personalized items for the user's evaluation over time.

If the user chooses to accept the items, they rate the item, 107; functionally, this involves the user applying a (click or touch) drag-and-drop mechanism to the item—as shown in FIGS. 5A to 5D and FIGS. 14A to 14D, which correspond to user interactions on the mobile device and desktop/notebook embodiments, respectively—and the structured criteria of the Perception pH® rating spheres shown in FIGS. 5A to 41C.

This (click or touch) drag-and-drop mechanism inputs the item and its rating into the database and updates the relevant components of the system, 108.

At any time point in the data collection process, the user has the option to stop their evaluation activity or to continue, 109. Any items they've evaluated will be stored in the system's memory and may be offered to the user as an item to rate again at a future date. This is done as a process of “training the machine” to enable it to calibrate, track and benchmark the user's perception ratings of items and the changes of those perception ratings over time.

The structuring and processing of items is shown in FIG. 2A and this operates in parallel to the structuring and generation of User Profiles shown in FIG. 2B. Collectively, this contiguous execution within the system generates more personalized clusters of items that match with the user's Perception Profiles over time.

Items used by the system are either pre-seeded, extracted from multiple sources—including from Open Source libraries and social media APIs (shown in FIG. 3B: 321 and 322) and also self-inputted by users. These items include, and are not limited to: text, images, videos, links, sounds, pictographs, signs & symbols, maps and emoticons. When the item arrives within the system 201, it is filtered for suitability, 202. Suitability is defined by whatever functional system criteria produce the optimal quality and quantity of the data within the system. In the case where the item is of an inappropriate nature, such as: pornographic, offensive, illegal, obscene, abusive or defamatory as defined by the Communications Decency Act 1996, it will be immediately rejected and binned into the Items Blacklist Database, 203. These steps enable the system to crosscheck and process the same item appropriately if it appears in the system in the future.

For items filtered in as being suitable, the system further tags and categorizes them into type clusters, 204 (Text, Images, Videos, Links, Sounds, Pictographs, Signs & Symbols, Maps and Emoticons examples in 205). At the same time, the system tags and assigns the item into perception clusters 206 which are further categorized according to:
Directional orientation 208 (Negative, Neutral, Positive, Dual wherein an item has both negative and positive interpretations);
Numerical value 209 (with the number indicating the intensity of the directional orientation: −3=Most Negative, −2=More Negative, −1=Negative, 0=Neutral, +1=Positive, +2=More Positive, +3=Most Positive);
Color value 210 (Red=Most Negative, Orange=More Negative, Yellow=Negative, Green=Neutral, Blue=Positive, Indigo=More Positive, Violet=Most Positive; or any appropriate RGB value corresponding to the directional orientation);
Word associations 211 (e.g.: adjectives, adverbs, nouns, verbs, acronyms, abbreviations, signs and symbols; and their directional orientations);
Gender 212 (Male, Female, Neutral and Dual whereby an item is associated with both genders); and
Age of comprehension 213 (Professional-Technical, Degree-level, 16+ years, 12-16 years, 9-11 years, 5-8 years, 3-4 years, 0-2 years).

In tandem, the system assigns semantic structures to the item, 207.

Initially, these tag assignments are based upon the perceptions and biases of the system's inventor(s) and small sample population of users. Over time, Artificial Intelligence and Machine Learning methods will be deployed in such a way that the assignments of perceptions to the items are based on the consensus “wisdom of the crowds” and also personally unique to and personalized for the user.

In parallel with the processes involved in perception clustering, the system designates semantic structures for each item, shown by 207. The system applies semantic structures based on those provided by the World Wide Web Consortium (W3C) and by schema.org as well as its own novel hybrid Quantum Mechanics-semantic structures of the form:

<subject|subjunctive_predicate verb∥PerceptionpH_keyword:=descriptive∥object∥object_philia:=perceptual intensity or Perception pH|object>

and its variations.

The outputs of the perception clusters, indicated by 214 to 219, and semantic assignments are then cohered by the system 220, applying a flexible weighting mechanism for each output, and connected with User Profiles 221 to create composite records of items and users within the database clusters. Coherence is partly obtained by applying Natural Language Processing (NLP) methods, which are understood by anyone skilled in the art.

The complementary flow process to the Items one is shown in FIG. 2B. This covers the categorization of information related to Users and User Profiles, 222. In a similar way to the processing of Items, this system initially filters out Users according to their suitability or otherwise, 223. Suitability is defined by whatever functional system criteria produce the optimal quality and quantity of the data within the system. Wherein possible, the user login and registration process will exclude users with fake profiles, remove duplications and those who are not within prerequisite age limits. The system adopts robust user authentication measures (not shown in diagrams) that would be understood by anyone skilled in the art. Rejected users and their details are collected into the Users Blacklist Database, 224, which enables the system to cross-check and process the same user appropriately if they try to login or register into the system in future.

Once accepted by the system, users indicate their topics of interest via a set of Q&As. These steps enable the system to categorize them into interest clusters, 225 and 226 (including and not limited to: Automotive, Beauty & Cosmetics, Consumer Electronics, Fashion Retail, Finance, Healthcare, Interior Design, Leisure & Travel, Media, and further sub-categories). Following these steps, users are processed into perception clusters 227 according to the way they rate items:
Directional orientation 229 (Negative, Neutral, Positive, Dual wherein an item has both negative and positive interpretations);
Numerical value 230 (with the number indicating the intensity of the directional orientation: −3=Most Negative, −2=More Negative −1=Negative, 0=Neutral, +1=Positive, +2=More Positive, +3=Most Positive);
Color value 231 (where Red=Most Negative, Orange=More Negative, Yellow=Negative, Green=Neutral, Blue=Positive, Indigo=More Positive, Violet=Most Positive; or any appropriate RGB value corresponding to the directional orientation);
Word associations 232 (e.g.: adjectives, adverbs, nouns, verbs, culture identity, acronyms, abbreviations, signs and symbols; and their directional orientations);
Gender 233 (Male, Female, Neutral and Dual wherein an item is associated with both genders); and
Age of comprehension 234 (Professional-Technical, Degree-level, 16+ years, 12-16 years, 9-11 years, 5-8 years, 3-4 year, 0-2 years).

This filtration process is oriented to collect and analyze the user's pre-existing perception biases and to enable the system to make appropriate weightings adjustments. At the same time that 227 is executed, the system assigns an identity structure to the user 228 which includes a unique identifier and socio-demographic information pooled from their online activity and information related to their self-inputted topics of interest.

The outputs of the perception clusters, indicated by 235 to 240, and identity structure assignments are then cohered by the system 241, applying a flexible weighting mechanism for each output, and connected with the Items for Rating 242 to create composite records of items and users within the database clusters. Coherence is partly obtained by applying Natural Language Processing (NLP) methods, which are understood by anyone skilled in the art.

FIG. 3A shows in more illustrative detail an example architecture framework for the system's Client 315, Application Server 308, Databases (example cloud clusters of 301,302, 303, 304, 305, 306 and 307) and an Application Layer 314 that governs communications with client devices as well as the Application Programming Interface (APIs) of various websites. FIG. 3B provides a schematic of how data is collected, inputted, processed, categorized, evaluated and generated within cloud cluster 301. There may be multiple cluster databases over time, to adapt to and service the increasing volumes and structural dynamics of the data appropriately. For the application server 308, the components 309-313 shown in FIG. 3A may each be implemented in hardware, software or a combination of hardware and software as shown in FIG. 3A. The components 309-313 may be collectively a perception backend component. The data visualization generator 312 may be a user interface component. The advertising and leaderboards generators 312, 313 may be collectively a recommendation component.

Starting with FIG. 3A, the embodiments of the Client 315 could include and not be limited to: desktop PCs, tablets or notebooks, smartphones, smart TV devices and any other device that can access the system and interact with it. Components 316 to 321 are provided as examples of functionalities that may be delivered by the system to the Client, and this is contingent upon the specifications of each client device, e.g., screen size, click/touch interactivity, processing power, security capabilities and data reception. Similarly, the Server 308 and its components of 309 to 313 is one implementation of the system but not the only one.

It should be noted that an amount of data will be pre-populated or “seeded” into the databases which are categorized into two main groups: those relating to Consumers 301 and those relating to Brand Companies 305 with the bridging cluster of User Profiles 304 between the two.

Within the 301 Cloud, the system further stratifies the clusters into two that specifically correspond to Items for Ratings 303 and Ratings Definitions 302. These are directly affected and effected by the items and users flow processes shown in FIGS. 2A and 2B respectively and described previously. Depending on the volume of inputs by consumers received by the system and the weighting mechanisms applied, the Items for Rating and Rating Definitions adjust to produce personalized composites that are relevant to the consumer. For example, if the consumer persistently interacts with Items of Rating relating to Beauty & Cosmetics or rates those items with a Most Positive value, the system registers these inputs, infers the consumer's gender without them explicitly disclosing this and prioritizes items to suggest to the consumer that have strong connotations with Beauty & Cosmetics alongside randomized items that are not directly tagged as Beauty & Cosmetics. An example random suggestion would be an item of Interior Design that matched the color value that the consumer previously indicated when they were rating an item of Beauty & Cosmetics.

Within the 305 Cloud, the system further stratifies the clusters into two that specifically correspond to Items for Rating 306 and Ratings Definitions 307. These are directly affected and effected by the items and users flow processes shown in FIGS. 2A and 2B respectively, and described previously. Depending on the volume of inputs by the company received by the system and the weighting mechanisms applied, the Items for Rating and Rating Definitions adjust to produce personalized composites that are relevant to the brand. For example, if the brand company persistently rejects Rating Definitions relating to Most Negative values, which indicates that they prefer consumers not to be able to use these values when rating the brand's items, the system will register these inputs. It will then make a weighting adjustment that accounts for the brand's biases towards positive definitions and compares these biases relative to peer brands. If the biases are within a probabilistically acceptable range, the brand will be able to continue using these Rating Definitions. However, if the biases are outside the probabilistically acceptable range, the system will designate negatively oriented Ratings Definitions to align the brand with its peer competitors Ratings Definitions for more intelligent like-for-like comparison. For example, if Brand A's chosen Ratings Definitions comprises 99% of Most Positive values whilst the average of peer competitor's Ratings Definitions comprises 55-60%, the system will introduce negatively-oriented Ratings Definitions that lowers the 99% closer to the competitive average.

The functional treatment of Items of Ratings and Ratings Definitions for consumers and companies is independent from each other, in order to maintain system objectivity and integrity. There is a bridging cluster 304 which contains the User Profiles with their unique identifier and socio-demographic information pooled from their online activity and information related to their self-declared topics of interest. However, consumers do not directly interact, affect or effect the Items of Ratings and Ratings Definitions of the brands or vice versa. The system applies appropriate separating security layers between the Consumers and Brands database clusters to ensure this and each party gains access to the system via their own separate client UI.

The system's algorithms cohere their respective Items for Rating and Ratings Definitions to construct various sets of items and ratings spheres that appear on the client device, 317 and 318. Via (click or touch) drag-and-drop mechanisms, the user rates the items as shown in examples FIGS. 5A to 5D and FIGS. 14A to 14D. The user's selections are registered and routed into database records relevant to their user identity, within the Consumer clusters 301, as well as associatively tagged by the system to the brands that the user's selections have indicated they favor.

Data inputted independently by consumers and companies accumulate to the server components tasked with generating recommendation suggestions for the consumer, deploying dashboard tools for companies to target and promote their goods, services and experiences, and provisioning the benchmarking and tracking of Perception PH® for each item voted upon. An implementation of these components are the Data Visualization Generator 311, the Advertising Generator 312 and the Leaderboards Generator 313 whose results are presented on the client UI as Data Visualization widgets 319, Ad Mind Maps 320 and Leaderboards 321.

Examples of output Data Visualizations and Recommendations are shown in FIGS. 41C to 50. An embodiment of Advertising Mind Maps, based on user perceptions, is shown in FIGS. 45, 49B and 49E. These will be disclosed in more detail in paragraphs [0172] and [0173].

Explaining the Consumer clusters of 301 alongside FIG. 3B in more illustrative detail, the data records for Items for Ratings 302 are created within the database from two sources: External (Mobile 322 and Web 323) and by the self-input of the consumer-user through their client device 327. External sources encompass data extracted 324 from publicly available APIs through tools including Amazon Mechanical Turk; referenced on Wikipedia; documented on the API directory of Programmable Web; provided in Linked-Data-Open Data-Open Source libraries; and any other similar directories. Again, as described in paragraph [0097], items may be removed and deposited into the Items Blacklist Database 326 if they don't meet the systems criteria during verification and validation processes 325.

Upon the item being accepted by the system, it is categorized into item type 328 (e.g., text, images, videos, links, sounds, pictographs, signs & symbols, maps and emoticons) before the item is semantically tagged by the Semantic Structure Designator 329 in the code formats explained in paragraphs [0064] and [0098].

In parallel, within the Rating Definitions cluster 302, the system assigns the relevant and matching tags for directional orientation from the Orientation Evaluator 330, numerical values from the Number Evaluator 331, colors from the Color Evaluator 332, word associations from the Word Evaluator 333, gender identity from the Gender Evaluator 334 and level of age comprehension from the Comprehension Evaluator 335. These assigned values contribute to the Ratings Sphere Generator 309 and, in combination with the Items Generator 309, surfaces the personalized Items for Rating 317 on the client interface 315 for them to interact with.

The requirement for the system to provide such specific categorizations of item types, Perception pH® value assignation and semantic structure designations reflects the system's functional objectives to collect, calibrate, analyze and cohere data qualitatively as well as quantitatively. Moreover, it implements this system's differentiated methodology towards market research, data analytics and machine intelligence from prior art.

The marketing method of FIG. 4A, widely known as the “Marketing Matrix”, which affects how prior art market surveys and data analytics has been executed was first described in 1960 as a 4P method by Edmund Jerome McCarthy, Professor of Marketing at Michigan State University. Its foundations have been built upon and used by marketers since then. The method states that when a company wants to establish itself and succeed in its target market 401, it has to strategize for the following 4Ps: Product 402, an tangible good or intangible service that satisfies a consumer's need and/or want; Price 403, an amount of currency which is paid by the consumer to secure the good or service; Place 404, a location or destination where the good or service is made available to the consumer; and Promotion 405, a series of communications, marketing and advertising efforts to make the consumer aware of the goods and services, their prices and the place where they're available.

Those prior art definitions lend themselves to the collection of quantitative data found in Likert and Osgood era surveys described earlier from paragraph [0009] onwards: Product (e.g., dimensions of the product, number of product made, number of product sold/unsold); Price (e.g., $ amount the price is sold for, $ cost of production); Place (e.g., address, geolocation, proximity in kilometers); and Promotion (frequency count of survey responses, number of ticks or crosses in the box).

In 1981, Bernard H. Booms and Mary Jo Bitner expanded McCarthy's 4P marketing method to 7P by adding: Physical Evidence 406, the layout and environment of the place where consumers experience and buy their goods and services; People 407, the consumer themselves as well as the personnel and business partners of the company who provide the consumer with goods and services; and Process 408, the procedures, timing and sequence of activities done by the company that result in the consumer's experience of goods and services. Again, with the advent of the Internet and mobile devices, these prior art marketing methods led to the quantitative types of data collected and analyzed: Physical Evidence (e.g., numbers relating to venue, capacity, accessibility); People (e.g., frequency counts of “likes”, “retweets” and “wishlists”, how many fans/friends/followers/connections as well as socio-demographics data such as amount of monthly expenditure, age, number of children, geo-location of where they live); and Procedures (e.g., speed of click-to-purchase conversion, prioritized listings of search results, automated emails).

The method of this system, which affects its functionalities, is shown in FIG. 4B and is a departure from McCarthy's 4P and Booms and Bitner's 7P marketing method foundations. Starting with its own novel foundations, this method establishes that People (consumers) 409 are driven by a Purpose (play, purchase of a good and/or service and/or experience, and expression of personal identity) 410 that leads them to engage in a Process (participation and search) 411, in order to acquire and satisfy their purposes. They therefore engage (alone and/or with others) and seek out Products, Prices, Places and Promotions 412 where they might be able to fulfill their purpose. This leads them to use tools that help them to quantify and compare their options through the prisms of themselves as well as their wider social communities, 413. These tools of Proof include search engines, social networks, review sites and online stores where the consumer can crosscheck a range of quantitative information that's available to help them make their purchasing and experience decisions. Examples of this quantitative information include: the price of the product or service; the listing order of the product or service; the number of “likes”; the number of followers and various numbers corresponding with social media activity relating to the product or service such as tweets, shares and bookmarks.

Separately and independently, another marketing process takes effect. People (companies) 416 are driven by a Purpose (provision of a good and/or service and/or experience) 417 that leads them to engage in a Process (planning, production and proposition) 418 to deliver on and realize their purpose. This leads them to generate Products, Prices, Places and Promotions 419 that they can offer to consumers. Subsequently, they use tools that help them to quantify and compare their market success through the prisms of their own internal benchmarking as well as in comparison with market competitors, 420. These tools of Proof include online analytics, social metrics, customer feedback and store sales where the company can crosscheck a range of quantitative information that's available to help them track their market success. Examples of this quantitative information include: the number of clicks their website gets; the number of “likes” they attract; the value and volume of the products and services they sell; the socio-demographic information they collect on consumers; and the numbers that correspond with the social media activity relating to the product or service they're concerned with such as tweets, shares and bookmarks.

In addition to this system and method having a different starting base from McCarthy and Booms & Bitner's methods, it explicitly incorporates a Platform through which to pool the consumer and the company data, via their portals 415 and 421 respectively. The dotted lines indicate the particular novel processes of the system. There is a prior process step to 415 that involves the extraction of available data, 414, from publicly accessible Application Programming Interface (API) including those of various well-known websites such as Facebook, Twitter, Google Plus, Yahoo BOSS, eBay, Amazon and others, and Open Source libraries.

The result of pooling the data collected from consumers and companies serves to create inputs into the Perceptions component 422 of the system. These inputs contribute to and are not limited to: User Profiles, Items for rating, Ratings definitions and Analytics (Perception and Semantic). Critically and advantageously, the system amalgamates, filters and coheres the data in a way which is consistent with its Perception pH® functional criteria. This means the system is able to produce Personalizations of the data items for the advantage of users.

The output from this method is Perspicacity 360-2020®, a series of qualitative and quantitative, perception-based Recommendations 423 which are provided to consumers and companies in formats of their choosing. These formats include and are not limited to: online and email notifications, SMS alerts, dashboards, online and mobile reports, data visualizations which are shown as examples in FIGS. 41C to 50. For companies, the data analytics enables them to measure, track and mind map the consumer's perception values of their brands, products, relationships, content and more. For consumers, they can compare their perceptions relative to their social connections and to the companies' competitors' brands, products, relationships, content and more to help them make choices of what they decide to buy.

Before system outputs are described in greater detail, the input mechanisms are shown in FIGS. 5A to 41B for the mobile tablet and desktop-notebook embodiments. These input mechanisms, or survey processes, use a novel 2TOUCH™ (click or touch) drag-drop which is different from the “push/click the button” and “select the dropdown option” systems of prior art in market research. For the purposes of keeping this disclosure within a reasonable length, the drawings for smartphones and smart TV devices have been omitted. However, it should be appreciated that the principles and spirit of those input interactions are the same as the diagrams shown, albeit with screen sizes and formats that are more appropriate for the smart phone and the smart TV device.

Starting with the mobile tablet embodiment shown in FIGS. 5A to 5D, the system is directly deployable and accessible via the browser 501 onto the client's touchscreen UI 502. Applying appropriate responsive components known by those skilled in the art, the system adjusts to fit to the screen dimensions of the client device. 503 refers to the system's navigation bar for the user, an embodiment of which is shown in more detail in FIG. 40. Near the top of each page shown on the UI there is a topic identity 504 and a series of one or more Advertising buttons 505. On click of these Advertising buttons, the system re-directs the user to the Ad Mind Maps referred to in paragraph [0126] and shown in FIGS. 3A: 320, 45, 49B and 50: 5001.

Directly above the Advertising buttons is Settings 506 which directs the user to Personalization Panels (not shown in the diagrams) that enable them to adjust their user settings, including privacy selections and which Items for Rating they prefer. Below the Advertising buttons are: the Graph button 520 which directs the user to real-time updates of Data Visualizations and Recommendations of the type shown in FIGS. 42 to 50, based on survey results; the Get button 521 which directs the user to a functionality (e.g., an online shopping basket or to an affiliate site) that enables them to purchase products shown on the page; the Undo button 522 which lets the user undo any item they've inputted into the spheres 511 to 519; the Go Social panel 523 which lets users save, share and compare their Perception pH® ratings of items across appropriate social media communities; and the Leaderboard 524 which enables them to track which items they've rated highly or low in a gamefication, social and reputational way.

On the left hand side of the screen is a column of (click or touch) drag-and-droppable components 507, which hold the Items for Rating and can be manipulated by the user's touch interactions 510. Within each single component holder are a link 508 (in this example, for Text) and a linked image 509 for that item, which is to be rated by the user. There are pre-seeded items as well as a feature for the user to input and upload their own items for rating. On click or touch activation of the links, the system deploys a popup window (not shown in diagrams) which either shows the user the website where the item is available or additional information for the item.

During the 2TOUCH™ survey process the user activates the entire component of 507. They are stacked vertically in a column as shown in FIG. 5A and also one-on-top-of-the-other, as indicated by the label (507-509)N. The first layer component is (507-509)1 as shown in FIG. 5B, which, after it has been moved from its original location by the user's touch, reveals a second layer component (507-509)2 seen in FIG. 5C. A third layer component would be (507-509)3, a fourth (507-509)4 and so on. This multi-layer design has been made to encourage the user to stay on the page rather than need to click through to another page to see more items for ratings.

A novel functionality of this system is found in the center of the client UI screen: the Perception pH® rating spheres. These are positioned as follows: at North 0° and 360° is 511, at North-East 45° is 512, at East 90° is 513, at South-East 135° is 514, at South 180° is 515, at South-West 225° is 516, at West 270° is 517, at North-West 315° is 518; and these spheres encircle a larger central sphere 519.

Furthermore, each Perception pH® sphere carries a color and numerical value to indicate the directional orientation of the rating (negative, neutral or positive) and the intensity of that orientation like so:
511 has a green colored circumference and the number 0 in its center;
512 has a violet colored circumference and the number +3 in its center;
513 has an indigo colored circumference and the number +2 in its center;
514 has a blue colored circumference and the number +1 in its center;
515 has a green colored circumference and the number 0 in its center;
516 has a yellow colored circumference and the number −1 in its center;
517 has an orange colored circumference and a number −2 in its center;
518 has a red colored circumference and a number −3 in its center; and
519 has a silver colored circumference and the words “Thanks, not rating it!” in its center.

The higher the +N within the sphere, the more favorably the rating being assigned to the item. The lower the −N within the sphere, the less favorably the rating being assigned to the item. The colors of the circumferences correspond with directional orientation such that: red=most negative; orange=more negative; yellow=negative; green=neutral; blue=positive; indigo=more positive and violet=most positive. In some versions of the rating spheres, for example in assigning cultural identity, all of them have a silver colored circumference so that none is associated with being red=negative, green=neutral, violet=positive or any other color.

FIG. 5B shows the user selecting the (507-509)1 component and moving it via touch, indicated by label 523, towards one of the Perception pH® rating spheres of their choice. As they do so, FIG. 5C reveals the (507-509)2 component in the layer below the (507-509)1 component. The user drops the component into any Perception pH® rating sphere 511-519 they choose. The system inputs their selection into the relevant databases for processing and generates analytics and recommendations from these inputs.

If the user wishes to un-do their last action, they select the backward arrow button 522. If they'd like a different set of Items for Rating, they select User Settings 506 and adjust their Personalization Panels. If they're happy with their selection, they can continue with the system's 2TOUCH™ survey processes to rate items as shown in FIG. 5D.

The 2TOUCH™ survey processes of the system is the same on mobile tablets regardless of the type of item being rated. This is shown in FIG. 6 for Videos, FIG. 7 for Sound files, FIG. 8 for Pictographs, FIG. 9 for Words (which include and are not limited to: acronyms, adjectives, adverbs, nouns and verbs), FIG. 10 for Numbers, FIG. 11 for Symbols (which include and are not limited to: currencies such as $, ©, ∂, ✓ and #), FIG. 12 for Maps, FIG. 13 for Emoticons.

The 2TOUCH™ survey processes of the system is also the same when the system is accessible via a browser of a desktop or notebook device as shown in FIGS. 14A to 22. The UI design and page layouts are consistently applied across the mobile tablet embodiment of the system shown in FIG. 5A and the desktop/notebook embodiment shown in FIG. 14A as well as on smart TV devices (not shown in diagrams). The only difference is that, at the time of disclosure, desktops and notebooks continue to use mouse clicks and the diagrams from FIGS. 14A to 22 reflect this method of user input. However, it should be understood that this system is entirely adaptable to touchable desktop/notebook screens and any changes made to the embodiments do not depart from or reduce the true spirit and scope of the disclosed system and method.

For completeness of diagram references: FIG. 15 is the desktop/notebook embodiment for rating Videos: FIG. 16 for Sounds; FIG. 17 for Pictographs; FIG. 18 for Words (which include and are not limited to: acronyms, adjectives, adverbs, nouns and verbs), FIG. 19 for Numbers; FIG. 20 for Symbols (which include and are not limited to: currencies such as $, ©, ∂, ✓ and #), FIG. 21 for Maps, FIG. 22 for Emoticons.

FIGS. 23 to 36 show that in addition to embodiments of the Perception pH® rating spheres for directional orientation ranging from −N through 0 to +N as seen in FIGS. 5A to 22, there can also be the following embodiments:
FIGS. 23 and 24 for mobile tablet and desktop/notebook, respectively: 2311 is a Perception pH® rating sphere positioned at North 0° or 360° with a green colored circumference; 2312 is at North-East 45° with a violet colored circumference; 2313 is at East 90° with an indigo colored; 2314 is at South-East 135° with a blue colored circumference; 2315 is at South 180° with a green colored circumference; 2316 is at South-West 225° with a yellow colored circumference; 2317 is at West 270° with an orange colored circumference; 2318 is at North-West 315° with a red colored circumference; and 2319 has a silver colored circumference and the words “Thanks, not rating it!” in its center. This allows the user to rate the item purely by its color. It should be understood that instead of the name of the color, an RGB value could also be used. Red represents the most negative color whilst violet represents the more positive color the user can assign to the item.
FIGS. 25 and 26 for mobile tablet and desktop/notebook, respectively: 2511 is a Perception pH® rating sphere positioned at North 0° or 360° with a green colored circumference and a “Neutral Adjective” in its center; 2512 is at North-East 45° with a violet colored circumference and a “Most Positive Adjective” in its center; 2513 is at East 90° with an indigo colored circumference and a “More Positive Adjective” in its center; 2514 is at South-East 135° with a blue colored circumference and a “Positive Adjective” in its center; 2515 is at South 180° with a green colored circumference and a “Neutral Adjective” in its center; 2516 is at South-West 225° with a yellow colored circumference and a “Negative Adjective” in its center; 2517 is at West 270° with an orange colored circumference and a “More Negative Adjective” in its center; 2518 is at North-West 315° with a red colored circumference and a “Most Negative Adjective” in its center; 2519 has a silver colored circumference and the words “Thanks, not rating it!” in its center. An example of adjectives ranging from “Most Negative” to “Most Positive” would be: “abysmal, boring, uninteresting, average, timely, cool, brilliant.” If we suppose that the item being rated is a piece of media content, this embodiment of the system would enable the user to rate the content according to its utility and why they liked or didn't like it.
FIGS. 27 and 28 for mobile tablet and desktop/notebook, respectively: 2711 is a Perception pH® rating sphere positioned at North 0° or 360° with a green colored circumference and a “Neutral Gender” in its center; 2712 is at North-East 45° with a violet colored circumference and a “Male Positive” in its center; 2713 is at East 90° with an green colored circumference and a “Male Neutral” in its center; 2714 is at South-East 135° with a red colored circumference and a “Male Negative” in its center; 2715 is at South 180° with a green colored circumference and a “Dual Gender” in its center; 2716 is at South-West 225° with a red colored circumference and a “Female Negative” in its center; 2717 is at West 270° with an green colored circumference and a “Female Neutral” in its center; 2718 is at North-West 315° with a violet colored circumference and a “Female Positive” in its center; 2719 has a silver colored circumference and the words “Thanks, not rating it!” in its center. This embodiment lets the user assign items to gender associations that they have with the item. These associations have a directional orientation (e.g., negative, neutral, positive, dual) alongside the intensity of that orientation indicated by the color.
FIGS. 29 and 30 for mobile tablet and desktop/notebook, respectively: 2911 is a Perception pH® rating sphere positioned at North 0° or 360° with “0-2 years” in its center; 2912 is at North-East 45° with “3-4 years” in its center; 2913 is at East 90° with “5-8 years” in its center; 2914 is at South-East 135° with “9-11 years” in its center; 2915 is at South 180° with “12-16 years” in its center; 2916 is at South-West 225° with “16+ years” in its center; 2917 is at West 270° with “Degree-level” in its center; 2918 is at North-West 315° with “Professional-Technical” in its center; and 2919 has a silver colored circumference and the words “Thanks, not rating it!” in its center. This allows the user to rate the item according to the age level at which they believe the item would be understood. For example, a word like “concatenation” could be rated by the user as Professional-Technical since it's applied as functional language in a computer program to join two strings of characters end-to-end whilst an image of a “cat” would be rated as “0-2 years” since toddlers have ready grasps of one syllable words and everyday objects like cats, dogs, buses, trees and so on.
FIGS. 31 and 32 for mobile tablet and desktop/notebook, respectively: 3111 is a Perception pH® rating sphere positioned at North 0° or 360° with a green colored circumference and a “Neutral Verb” in its center; 3112 is at North-East 45° with a violet colored circumference and a “Most Positive Verb” in its center; 3113 is at East 90° with an indigo colored circumference and a “More Positive Verb” in its center; 3114 is at South-East 135° with a blue colored circumference and a “Positive Verb” in its center; 3115 is at South 180° with a green colored circumference and a “Neutral Adjective” in its center; 3116 is at South-West 225° with a yellow colored circumference and a “Negative Verb” in its center; 3117 is at West 270° with an orange colored circumference and a “More Negative Verb” in its center; 3118 is at North-West 315° with a red colored circumference and a “Most Negative Verb” in its center; 3119 has a silver colored circumference and the words “Thanks, not rating it!” in its center. This allows the user to indicate their action orientation towards the item. For example, the verb range from most negative (red) to most positive (violet) might be: dump, sell, transfer, hold, assess, invest and accumulate.
FIGS. 33 and 34 show another example of action orientations in the Perception pH® rating spheres for mobile tablet and desktop/notebook, respectively: 3311 is a Perception pH® rating sphere positioned at North 0° or 360° with a green colored circumference and a “Watch” in its center; 3312 is at North-East 45° with a violet colored circumference and a “Trust” in its center; 3313 is at East 90° with an indigo colored circumference and a “Want” in its center; 3314 is at South-East 135° with a blue colored circumference and a “Like” in its center; 3315 is at South 180° with a green colored circumference and a “Neutral Adjective” in its center; 3316 is at South-West 225° with a yellow colored circumference and a “Dislike” in its center; 3317 is at West 270° with an orange colored circumference and a “Reject” in its center; 3318 is at North-West 315° with a red colored circumference and a “Distrust” in its center; 3319 has a silver colored circumference and the words “Thanks, not rating it!” in its center.
FIGS. 35 and 36 show example cultural orientations in the Perception pH® rating spheres for mobile tablet and desktop/notebook, respectively: 3511 is a Perception pH® rating sphere positioned at North 0° or 360° with a silver colored circumference and a “Jewish” in its center; 3512 is at North-East 45° with a silver colored circumference and a “Arab” in its center; 3513 is at East 90° with silver colored circumference and a “Chinese” in its center; 3514 is at South-East 135° with a silver colored circumference and an “Indian” in its center; 3515 is at South 180° with a silver colored circumference and a “African” in its center; 3516 is at South-West 225° with a silver colored circumference and a “Latin” in its center; 3517 is at West 270° with an silver colored circumference and a “North American” in its center; 3518 is at North-West 315° with a silver colored circumference and a “European” in its center; 3519 has a silver colored circumference and the words “Thanks, not rating it!” in its center.

Whilst the embodiments described above are the typical ones by which this system may be applied, FIGS. 37 to 39 show customized examples of how the system might be adapted and executed as a mobile application and for eCommerce as a Point-of-Purchase shopping basket. The image on the left of FIG. 37 shows the 2TOUCH™ survey process applied to the market surveying of Beauty & Cosmetics products with the items for rating presented as images and the ratings definitions appearing as adjectives (in this example, in alphabetical order: “amazing, beautiful, chic, classic, easy, fresh, gorgeous, instant, light, long-lasting, moist, natural, quick, revolutionary and sexy.” Here, instead of dragging and dropping the items and ratings definitions into a Perception pH® rating sphere, the user puts them into an image of a cosmetics bag, 3701. The bag acts like a shopping basket and routes the user's selection into the relevant databases for processing. The image on the right in FIG. 37 shows the system presenting the Items for Ratings in three columns (e.g., Cameras, Laptops and Mobiles) with three Perception pH® rating spheres at the bottom (e.g., from left to right: a red colored sphere with “No thanks” wording above it to indicate a negative action orientation; green colored sphere with “Hmmn” wording above it to indicate a neutral or on-the-fence action orientation; and a purple colored sphere with “Want” wording above it to indicate a positive action orientation). Again, the user can drag-and-drop items from any of the three columns into the Perception pH® rating spheres below, 3702. Both examples in FIG. 37 reflect the system's potential as both a market surveying technology to measure why consumers buy and a Point-of-Sale shopping basket system to facilitate purchase transactions, contingent upon the system integrating with an appropriate payment system (not described in this disclosure).

FIG. 38 shows an example embodiment of the system and method deployed as a shopping basket at Point of Purchase via the user's device (mobile, desktop/notebook, tablet or smart TV device), whereby the item—in this case a Consumer Electronics product 3801, the purpose it's being bought for 3802 and the user's perceptions of the product 3803—are (click or touch) drag-droppable into the sphere 3804 and processed.

A more advanced embodiment can be seen in FIG. 39 wherein an item panel 3901 contains any text, audiovisual, symbol and so on to be evaluated. The item 3902 is (click or touch) drag-droppable into the 3D rating sphere 3903 which contains rating panels 3904 that correspond with Perception pH®. Rating panels are color-coded with value assignments (red=−3 or most negative adjective; orange=−2 or more negative adjective; yellow=−1 or negative adjective; green=0=neutral adjective; blue=+1 or positive adjective; indigo=+2 or more positive adjective; and violet=+3 or most positive adjective) or categories such as topics of interest, cultural associations and word connotations.

Yet another embodiment of the system is as a plug-in shown in FIGS. 41A, 41B and 41C. Like the other embodiments, it is deployable via Web and mobile browsers. Starting with FIG. 41A, the item for rating is indicated by the label 4101; in this case, a television. To its right is the Sense Spheres® ratings plug-in, labeled 4102. Initially it appears as a single “+1” circle button with the circumference of the circle being a blue color and the “+1” also being a blue color. The user activates the Sense Spheres® by clicking or touching the blue “+1” button. This leads the single button to spiral out to reveal all seven rating buttons plus a yin-yang button shown in FIG. 41B. The yin-yang button is positioned at North 0°. Working clockwise from this point, the rating spheres are as follows: North-East 45°=purple +3; East 90°=indigo +2; South-East 135°=blue +1 button; South 180°=green 0; South-West 225°=yellow −1; West 270°=orange −2; and North-West 315°=red −3.

Furthermore, when the user clicks or touches a button a specific corresponding rating definition appears as a radio button or popup-on-hover panel. For example, the purple +3 sphere 4103 has a corresponding rating definition of “sharp”, labeled 4104. The radio button being filled in indicates the user's selection and the selection is inputted into the system's databases once the user selects the Vote button, 4105. If the user prefers not to vote but just wants to view the results of votes given by other users so far, they can select the View button, 4106.

FIG. 41C shows the output of the Sense Spheres® ratings plug-in votes. At the top is an aggregate number for the total number of votes, 4107. Below this is a bar chart segmented into three categories: Positive votes, 4108; Neutral votes, 4109; and Negative votes, 4110. Within each of these categories there are further corresponding rating definitions, e.g., “cool” 4111, its color bar 4112 and its percentage share of the total votes 4113 as well as the aggregate tally for that rating definition 4114.

The improved accuracy, relevancy and efficiency of this system compared with prior art can be seen in examples of the system's Data Visualization and Recommendation outputs in FIGS. 41C to 50. FIG. 42 shows the tracking Perception pH® for an item, e.g., an Apple iPad, for three ratings definitions 4201: “amazing” in the positively-oriented violet colored line; “average” in the neutral green colored line; and “awful” in the negatively-oriented red colored line. If the user wants the information, the system can show more granular detail for each graph point. The user can either click or touch drag the activation line 4202 and the detail automatically appears for that graph point, labeled 4203 and 4204.

FIG. 43 shows how the novel Perception pH®'s rating scale of −N through 0 to +N for the designation and tabulation of directional orientation and the intensity of the orientation means that the system can plot cumulative bars on both the negative and positive axis of the graph, 4301. Moreover, the ratings definitions are shown in the graph's key 4302 and their correspondent color-rating definition makes it easy to visually gauge the Perception pH® for the item, labeled 4303, 4304 and 4305. Notably, this negative and positive axis tracking would not be possible in the same way with the Likert 1 to 5 scale, the Osgood semantic 1 to 100 scale, 5-star systems, Plutchik, Russell, Scherer and other emotion scales including Stanford's Sentiment Treebank scale; all of which have underpinned market research, data analytics and machine intelligence processes in prior art.

Furthermore, FIG. 44 shows how the system provides a breakdown for negative, neutral and positive categories; in this case, positive adjectives 4401 such as words like “amazing”, “beautiful”, “dynamic”, “fast”, “innovative”, “light”, “practical”, “quirky”, “stylish”, “trustworthy” and “versatile” 4402 with their corresponding survey percentage votes 4403. This type of comprehensive breakdown for words is not provided by prior art in lexical databases such as Harvard General Inquirer, LIWC® and WordNet®.

The advantages and granularity of this system's output is further shown in FIGS. 46 and 47, which are Perception pH® matrices for Brands and Words, respectively. In the case of FIG. 46, it has a horizontal axis 4601 which runs from “Negative Perception” on the left to “Positive Perception” on the right and a vertical axis which plots the Brand Values 4602 in both positive and negative directions. Directly from the item ratings collected by the system, each brand is plotted onto the Perception pH® matrix, e.g. 4603. Moreover, the plot is color-enabled such that the item in the uppermost top right quadrant is violet-colored whilst the item in the furthest bottom left quadrant is red-colored. Items around the x=0 and y=0 axis are green-colored. In this way, the system has generated what can be considered to be colored columns of brands that resemble the colored columns of DNA. As with Brand ratings, the system can also produce Perception pH® matrix and DNA-esque colored columns for Words, as shown in FIG. 47. Its x-axis 4701, from “simple” on the negative-side to “complex” on the positive-side, makes use of the system's ability to combine the rating definition of Level of Age Comprehension with the rating definitions of Color and Numerical Value. Positively rated words are interpreted as “Fan” 4702 on the y-axis whilst negatively rated words are interpreted as “Foe”. Each word is then positioned onto this x-y axis 4703 to indicate whether it is favorably or otherwise associated with the brand. The higher up the Fan axis the word is, the more favorable the word's association with the brand. Brand Perception pH® and Word Perception pH® are two example output embodiments but not the only output embodiments; for example, the system also outputs Product Perception pH®, Relationship Perception pH®, Content Perception pH® and more.

The ratings collected by the system can also be plotted onto Perception pH® matrixes as clusters, shown in FIG. 48, which correspond with the percentage ratios of each −3, −2, −1, 0 and +1, +2, +3 rating relative to the aggregate number of total ratings collected to measure the Brand Value 4802 relative to the negative or positive axis 4801. Each cluster has a unique color tone, e.g.; 4803 is most positive so violet-colored; 4804 has a bottom half which is colored orange to indicate it's more negative and a top half which is colored indigo to indicate it's more positive; 4805 has a bottom half which is colored red (most negative) and a top half which is colored orange (more negative); and 4406 has a bottom half which is colored red (most negative) and a top half which is colored indigo (more positive).

A data visualization example of the system is the Mind Maps shown in FIGS. 45 and 49A to 49E. Applying the word “cool” as an example, 4901, the system accesses the items ratings and word association databases in such as way that the user can click or touch on the spheres of the Mind Maps, e.g. Products 4902, and launch Product Recommendation Panels 4903. These would also contain products that brands activate as adverts within the system via their client dashboards shown in FIG. 4B: 421. Alternatively, if the user is interested in synonyms 4904 of “cool” they activate that sphere and lists of words that mean or are interpreted in a similar way to “cool” are presented in the panels on the right, 4905. Cross-checking for cultural equivalents 4906 of the word “cool” is another functional capability of the system, as shown in the information panel 4907. From the extraction process shown in FIG. 3B: 324, the word “cool” in company press releases 4908 can also be pooled in and presented alongside its associations in a panel, 4909.

The system applies data visualization techniques not simply to connect disparate items, ratings and item associations but, importantly, to deliver recommendations in a different way from prior art. Two examples of this are shown in FIG. 50. The image on the left shows an embodiment of the 2TOUCH™ survey process with colored pins 5001 that can be directly deposited onto a Maps interface for a community to recommend place and product spots to their friends. The image on the right shows the Perception pH® Wheel which is touch-turnable and deployed directly on either a Web or mobile browser. Instead of the lists (dropdown and accordion) and grids of recommendations of prior art, the system lets the user rotate the Perception pH® Wheel by click or touch and choose which perceptual experience they're seeking, e.g. “Amazing” 4602. Upon the user's selection, the system matches the word selected with a corresponding colored pin and presents it to the user on the map.

It will be appreciated that the present disclosure describes linguistically and illustratively the diverse embodiments of this present system in sufficient detail to enable anyone skilled in the art to use the system. Moreover, it should also be understood that variations on the disclosed embodiments may be deployed and that these changes could be of a electrical, mechanical, logical and structural type, by anyone skilled in the art, without departing from or reducing the scope and spirit of the system and method disclosed.

Although comprehensive information has been provided in this disclosure, it by no means represents the complete embodiments of the system and method. The descriptive features, functions and drawings are provided for illustrative purposes rather than as limitations to any changes on the system and method.

While the foregoing has been with reference to a particular embodiment of the disclosure, it will be appreciated by those skilled in the art that changes in this embodiment may be made without departing from the principles and spirit of the disclosure, the scope of which is defined by the appended claims.

1. A system that surveys and evaluates items according to people's perceptions and generates recommendations based on people's perceptions, the system comprising:
a processor;
a perception backend component, implemented on the processor, the perception backend component configured to receive a plurality of items from one or more external sources, configured to generate a user interface that allows a user to rate an item using a perception scale and to receive recommendations based on the perception scale.

2. The system of claim 1 further comprising one or more computing devices that are each configured to couple to the perception backend component, each of the one or more computing devices being one of a mobile device, a personal computer, tablet computer, a notebook computer and a smart television device.

3. The system of claim 2, wherein each computing device has a processor and an application executed by the processor that interacts with the perception backend component, wherein the application is one of a browser application and a mobile browser application.

4. The system of claim 1, wherein the perception backend component further comprises a survey component that is configured to perform a drag and drop survey; the drag and drop functionality is the same whether actioned by a mouse click or by the touch of a finger.

5. The system of claim 1, wherein each item is one of word text, an image, a video, a link, a sound, a pictograph, a sign, a symbol, a map and/or an emoticon.

6. The system of claim 1, wherein the perception component is configured to combine one or more items selected by the perception component and one or more items selected by the user and wherein the perception component is configured to allow a user to select and evaluate the combined items.

7. The system of claim 1, wherein the perception component is configured to collect and categorize the items into one of more of a directional orientation, a numerical value that indicates an intensity of the directional orientation, a color value that indicates an intensity of a perception about the item, a gender value, an age of comprehension, a meaning and association, a synonym, an antonym, a sector application, a cultural classification and a relation to one of a brand, product, content and service.

8. The system of claim 7, wherein the perception component is configured to generate a perception rating scale that is used to collect and categorize the items.

9. The system of claim 8, wherein the perception rating scale has up to eight rating spheres surrounding a central rating sphere, wherein each rating sphere routes an item classified in that sphere into a database cluster.

10. The system of claim 8, wherein the perception rating scale further comprises a color spectrum of a rainbow ranging from red being most negative through green being neutral and violet being most positive.

11. The system of claim 8, wherein the perception rating scale further comprises a numerical scale ranging from −N through 0 to +N.

12. The system of claim 9, wherein the perception rating scale further comprises a numerical scale and the eight rating spheres each have a numerical value of 0, +3, +2, +1, 0, −1, −2, and −3, respectively.

13. The system of claim 9, wherein the perception rating scale further comprises a color spectrum of a rainbow and a numerical scale and the eight rating spheres each have a scale of violet (+3), indigo (+2), blue (+1), green (0), yellow (−1), orange (−2), red (−3) and RGB (−N, 0, +N), respectively.

14. The system of claim 9, wherein the perception rating scale further comprises a color spectrum of a rainbow and a numerical scale and the eight rating spheres each have a scale, clockwise from a north position, of green/neutral/0, violet/most positive/+3, indigo/more positive/+2, blue/positive/+1, green/neutral/0, yellow/negative/−1, orange/more negative/−2 and red/most negative/−3.

15. The system of claim 9, wherein the perception rating scale further comprises a color spectrum of a rainbow and a numerical scale and the eight rating spheres each have a scale, clockwise from a north position, of color/neutral/0, color/most positive/one of a positive number a positive percentage, color/most positive/one of a positive number and a positive percentage, color/positive/one of a positive number and a positive percentage, color/neutral/0, color/negative/one of a negative number and a negative percentage, color/more negative/one of a negative number and a negative percentage and color/most negative/one of a negative number and a negative percentage.

16. The system of claim 9, wherein the perception rating scale further comprises a color spectrum of a rainbow and the eight rating spheres each have a scale, clockwise from a north position, of green/neutral, violet/most positive, indigo/more positive, blue/positive, green/neutral, yellow/negative, orange/more negative and red/most negative and each of the rating spheres have one of an adjective, word, text or audiovisual associated with each of the rating spheres.

17. The system of claim 8, wherein the perception rating scale has one or more three dimensional colored spheres with each colored sphere having a rating panel, the rating panels being one of a violet panel that is most positive and has one of a positive number and a positive word associated with the violet panel, an indigo panel that is more positive and has one of a positive number and a positive word associated with the indigo panel, a blue panel that is positive and has one of a positive number and a positive word associated with the blue panel, a green panel that is neutral and has one of a zero or a neutral word associated with the green panel, a yellow panel that is negative and has one of a negative number and a negative word associated with the yellow panel, an orange panel that is more negative and has one of a negative number and a negative word associated with the orange panel and a red panel that is most negative and has one of a negative number and a negative word associated with the red panel.

18. The system of claim 1, wherein the user interface component of the perception backend component is configured to generate a perception scale user interface that is a button that spirals out into a circle of up to eight rating spheres.

19. The system of claim 18, wherein the user interface component of the perception backend component is further configured to generate, when a particular rating sphere is clicked, a user interface associated with the particular rating sphere.

20. The system of claim 1, wherein the user interface component of the perception backend component is configured to generate data visualizations of the items.

21. The system of claim 1, wherein the perception backend component further comprises a recommendation component that is configured to generate a recommendation based on the perception rating of the items.

22. A method implement on a computer having a processor, comprising:
receiving, by a perception backend component, a plurality of items from one or more external sources;
generating a perception scale user interface;
rating, using the perception scale user interface, an item based on a perception scale; and
generating recommendations based on a perception scale.

23. The method of claim 22 further comprising performing, using a survey component of the perception backend component, a drag and drop survey of one or more of the plurality of items.

24. The method of claim 22, wherein each item is one of word text, an image, a video, a link, a sound, a pictograph, a sign, a symbol, a map and an emoticon.

25. The method of claim 22 further comprising combining one or more items selected using the backend perception component and one or more items selected by the user and selecting and evaluating the combined items.

26. The method of claim 22 further comprising collecting and categorizing one or more of the plurality of items into one of more of a directional orientation, a numerical value that indicates an intensity of the directional orientation, a color value that indicates an intensity of a perception about the item, a gender value, an age of comprehension, a meaning and association, a synonym, an antonym, a sector application, a cultural classification and a relation to one of a brand, product, content and service.

27. The method of claim 26 further comprising generating a perception rating scale that is used to collect and categorize one or more of the plurality of items.

28. The method of claim 27, wherein generating the perception rating scale further comprises generating a perception rating scale having up to eight rating spheres surrounding a central rating sphere, wherein each rating sphere routes an item classified in that sphere into a database cluster.

29. The method of claim 28, wherein the perception rating scale further comprises a color spectrum of a rainbow ranging from red being most negative through green being neutral and violet being most positive.

30. The method of claim 28, wherein the perception rating scale further comprises a numerical scale ranging from −N through 0 to +N.

31. The method of claim 28, wherein the perception rating scale further comprises a numerical scale and the eight rating spheres each have a numerical value of 0, +3, +2, +1, 0, −1, −2, and −3, respectively.

32. The method of claim 28, wherein the perception rating scale further comprises a color spectrum of a rainbow and a numerical scale and the eight rating spheres each have a scale of violet (+3), indigo (+2), blue (+1), green (0), yellow (−1), orange (−2), red (−3) and RGB (−N, 0, +N), respectively.

33. The method of claim 28, wherein the perception rating scale further comprises a color spectrum of a rainbow and a numerical scale and the eight rating spheres each have a scale, clockwise from a north position, of green/neutral/0, violet/most positive/+3, indigo/more positive/+2, blue/positive/+1, green/neutral/0, yellow/negative/−1, orange/more negative/−2 and red/most negative/−3.

34. The method of claim 28, wherein the perception rating scale further comprises a color spectrum of a rainbow and a numerical scale and the eight rating spheres each have a scale, clockwise from a north position, of color/neutral/0, color/most positive/one of a positive number and a positive percentage, color/most positive/one of a positive number and a positive percentage, color/positive/one of a positive number and a positive percentage, color/neutral/0, color/negative/one of a negative number and a negative percentage, color/more negative/one of a negative number and a negative percentage and color/most negative/one of a negative number and a negative percentage.

35. The method of claim 28, wherein the perception rating scale further comprises a color spectrum of a rainbow and the eight rating spheres each have a scale, clockwise from a north position, of green/neutral, violet/most positive, indigo/more positive, blue/positive, green/neutral, yellow/negative, orange/more negative and red/most negative and each of the rating spheres have one of an adjective, word, text or audiovisual associated with each of the rating spheres.

36. The method of claim 28, wherein the perception rating scale has one or more three dimensional colored spheres with each colored sphere having a rating panel, the rating panels being one of a violet panel that is most positive and has one of a positive number and a positive word associated with the violet panel, an indigo panel that is more positive and has one of a positive number and a positive word associated with the indigo panel, a blue panel that is positive and has one of a positive number and a positive word associated with the blue panel, a green panel that is neutral and has one of a zero or a neutral word associated with the green panel, a yellow panel that is negative and has one of a negative number and a negative word associated with the yellow panel, an orange panel that is more negative and has one of a negative number and a negative word associated with the orange panel and a red panel that is most negative and has one of a negative number and a negative word associated with the red panel.

37. The method of claim 22, wherein the user interface component of the perception backend component is configured to generate a perception scale user interface that is a button that spirals out into a circle of up to eight rating spheres.

38. The method of claim 37, wherein the user interface component of the perception backend component is further configured to generate, when a particular rating sphere is clicked, a user interface associated with the particular rating sphere.

39. The method of claim 22, wherein the user interface component of the perception backend component is configured to generate data visualizations of the items.

40. The method of claim 22, wherein the perception backend component further comprises a recommendation component that is configured to generate a recommendation based on the perception rating of the items.
